(19) United States
(12) Patent Application Publication
(10) Pub. No.: US 2025/0153136 A1
(43) Pub. Date: May 15, 2025

(54) METAL-ORGANIC FRAMEWORKS-POLYMER FIBER-BASED ADSORBENT FORMING A CORE-SHELL STRUCTURE AND ITS MANUFACTURING METHOD, AND RARE EARTH METAL RECOVERY METHOD

(71) Applicant: KOREA INSTITUTE OF SCIENCE AND TECHNOLOGY, Seoul (KR)

(72) Inventors: Jae Woo CHOI, Seoul (KR); Youngkyun JUNG, Seoul (KR); Kyung-Won JUNG, Seoul (KR); Yun LEE, Seoul (KR); Sujin YOON, Seoul (KR)

(21) Appl. No.: 18/615,762

(22) Filed: Mar. 25, 2024

(30) Foreign Application Priority Data
Nov. 15, 2023 (KR) 10-2023-0158293

(51) Int. Cl. B01J 20/22; B01D 15/08; B01J 20/28

(52) U.S. Cl. CPC B01J 20/226; B01D 15/08; B01J 20/28023

(57) ABSTRACT

The present invention relates to a metal-organic framework-polymer fiber-based adsorbent having a core-shell structure and a method for preparing the adsorbent, and a method for recovering a rare earth metal using the same, which result in having easy recovery of the adsorbent together with excellent characteristics of a maximum adsorption amount and an adsorption rate for the rare earth metal. The metal-organic framework-polymer fiber-based adsorbent having the core-shell structure according to the present invention is characterized in that the metal-organic framework is provided on a surface of a sodium polyacrylate (NaPA) fiber.

### CROSS REFERENCE TO RELATED APPLICATION

The present application claims the priority ofKorean Patent Application No. 10-2023-0158293, filed Nov. 15, 2023, the entire contents of which is incorporated herein for all purposes by this reference.

### BACKGROUND OF THE INVENTION

### Field of the Invention

The present invention relates to a metal-organic framework-polymer fiber-based adsorbent having a core-shell structure and a method for preparing the adsorbent, and a method for recovering a rare earth metal using the same. More specifically, the present invention is directed to a metal-organic framework-polymer fiber-based adsorbent having a core-shell structure and a method for preparing the adsorbent, and a method for recovering a rare earth metal using the same, which result in having easy recovery of the adsorbent together with excellent characteristics of a maximum adsorption amount and an adsorption rate for the rare earth metal.

This invention was made with the support of the Ministry of Science and ICT under Project No. 1711191619, which was conducted under the research project entitled “Developing customized module to enhance applicability of reactive filter under extreme environment” within the project named “Nano Material Technology Development” under the management of the National Research Foundation of Korea, from Jan. 1, 2023 to Dec. 31, 2023.

### Description of the Related Art

A permanent magnet of Nd—Fe—B series, which is essential in various high-tech industries such as an aerospace, a clean energy, an electric vehicle, and a battery, is known to have a permanent magnetic force as long as there is no change in an external environment. However, heat, oxidation, moisture, reverse magnetic field, etc. in variously applied environments may cause a demagnetization phenomenon that reduces the magnetic force, thereby shortening the lifespan. For reference, the permanent magnet of Nd—Fe—B series is composed of approximately 65 wt % of Fe, 25 wt % of Nd, and 10 wt % of Dy (Green Chemistry, vol. 20, 1065-1073 (2018)).

Therefore, the permanent magnet that has been used in the industrial site for a certain period of time is discarded or recycled. Recycling of the permanent magnet involves recovering a rare earth metal (Nd and Dy in the case of the permanent magnet of Nd—Fe—B series) contained in the permanent magnet.

A method for recovering the rare earth metal is known to include a solvent extraction method, a precipitation method, a spray roasting method, a membrane separation method, an electrolysis method, and an adsorption method. The solvent extraction method (see Non-patent document 4) or the precipitation method requires the use of a large amount of environmental and biohazardous chemicals, and the spray roasting method has a disadvantage of consuming a larger amount of energy compared to the rare earth metal that can be recovered. Further, the membrane separation method or the electrolysis method has a limitation in the process efficiency due to low separation performance. Meanwhile, the adsorption method which utilizes an adsorbent has an advantage of being simple in a process and relatively economical compared to the other recovery methods.

In case the rare earth metal is recovered using the adsorbent, a maximum adsorption amount, adsorption rate, and ease of recovery of the adsorbent must be considered so as to increase an efficiency of the recovery process. In order to increase the recovery efficiency for the rare earth metal, the maximum adsorption amount and adsorption rate for the rare earth metal of the adsorbent must be excellent, and the recovery of the adsorbed rare earth metal and the recycling of the recovered adsorbent require easy recovery of the adsorbent.

“Chemical Engineering Journal, vol. 386, 124023 (2020)” (Non-patent document 2) discloses that a high adsorption amount of 249.90 mg/g or more for the rare earth metal such as Nd(III) can be achieved through nanoparticles of a 3D mushroom shape (UiO-66-NH2@ZIF-8) that form a metal-organic framework, but has a disadvantage in that it is not easy to recover the adsorbent on which the rare earth metal is adsorbed because the adsorbent is the nanoparticles.

“Chemical Engineering Journal, vol. 351, 832-840 (2018)” (Non-patent document 3) suggests a technology for recovering the rare earth metal through the form of a bead in which an amorphous ZrP is dispersed in PAN. The technology is easy to recover the adsorbent by virtue of having the bead in a size of mm, but has a poor adsorption property for the rare earth metal due to a maximum adsorption amount of 100 mg/g or less.

### SUMMARY OF THE INVENTION

The present invention has been developed to solve the above problems, and is aimed to provide a metal-organic framework-polymer fiber-based adsorbent having a core-shell structure and a method for preparing the adsorbent, and a method for recovering a rare earth metal using the same, which result in having easy recovery of the adsorbent together with excellent characteristics of a maximum adsorption amount and an adsorption rate for the rare earth metal.

The metal-organic framework-polymer fiber-based adsorbent having the core-shell structure according to the present invention for achieving the above object is characterized in that the metal-organic framework is provided on a surface of a sodium polyacrylate (NaPA) fiber.

The surface of the sodium polyacrylate (NaPA) fiber is provided with a sodium carboxylate group (—COONa). In addition, the surface of the sodium polyacrylate (NaPA) fiber may be provided with any one of an amine group (—NH₂), a carboxyl group (—COOH), a hydroxyl group (—OH), a sulfate group (SO₄²⁻), and a phosphate group ([PO₄]³⁻).

The metal-organic framework is ZIF-8.

The sodium polyacrylate (NaPA) fiber has several tens of micrometers or more in a diameter.

The metal-organic framework-polymer fiber-based adsorbent having the core-shell structure and the method for preparing the adsorbent, and the method for recovering the rare earth metal using the same according to the present invention is characterized by comprising the steps of: surface modifying a polyacrylonitrile (PAN) fiber with a sodium polyacrylate (NaPA) fiber having a sodium carboxylate group (—COONa); fixing a precursor of the metal-organic framework to a surface of the sodium polyacrylate (NaPA) fiber; and converting the precursor of the metal-organic framework into the metal-organic framework.

The step of surface modifying the polyacrylonitrile (PAN) fiber with the sodium polyacrylate (NaPA) fiber having the sodium carboxylate group (—COONa) is to immerse the polyacrylonitrile (PAN) fiber in a NaOH solution to substitute a nitrile group of the polyacrylonitrile (PAN) with the sodium carboxylate group (—COONa).

The step of fixing the precursor of the metal-organic framework to the surface of the sodium polyacrylate (NaPA) fiber consists of the processes of: immersing the sodium polyacrylate (NaPA) fiber in a metal solution having the metal dissolved therein to adsorb a metal ion on the surface of the sodium polyacrylate (NaPA) fiber, and forming the precursor of the metal-organic framework by extracting the metal ion in the form of metal hydroxide.

The process of forming the precursor of the metal-organic framework by extracting the metal ion in the form of metal hydroxide involves immersing the sodium polyacrylate (NaPA) fiber adsorbed with the metal ion in an ethanol solution to extract the metal ion in the form of metal hydroxide.

A method for recovering the rare earth metal using the metal-organic framework-polymer fiber-based adsorbent having the core-shell structure according to the present invention is characterized in that the rare earth metal in a solution having the rare earth metal dissolved therein is recovered by adding the adsorbent to the solution.

The recovery method may comprise the processes of dissolving Fe and the rare earth metal by adding a material consisting of the Fe and the rare earth metal to a solution of pH 1 to 2, precipitating the Fe component extracted by adjusting a pH of the solution to 4 or higher, and recovering the rare earth metal in the solution using the adsorbent.

A metal-organic framework-polymer fiber-based adsorbent having a core-shell structure and a method for preparing the adsorbent, and a method for recovering a rare earth metal using the same according to the present invention have the following effects.

Based on a high adsorption selectivity for the rare earth metal, it exhibits a maximum adsorption amount of 400 mg/g or more and has an adsorption rate that reaches adsorption equilibrium in a very short time. In addition, it is easy to recover the rare earth metal from the adsorbent because the adsorbent has a size of μm or more.

### BRIEF DESCRIPTION OF THE DRAWINGS

FIG. 1 is a flowchart illustrating a method for preparing a metal-organic framework-polymer fiber-based adsorbent having a core-shell structure according to an embodiment of the present invention.

FIG. 2 is a schematic diagram illustrating a method for preparing a metal-organic framework-polymer fiber-based adsorbent having a core-shell structure according to an embodiment of the present invention.

FIG. 3A shows a FT-IR analysis result indicating that a nitrile group of PAN is substituted with a sodium carboxylate group (—COONa) depending on an immersion time in a NaOH solution.

FIG. 3B is an experimental result showing an adsorption amount of a Zn metal ion depending on a type of the reaction solution.

FIG. 3C shows a FT-IR analysis result for a surface of a NaPA fiber.

FIG. 3D shows a XRD analysis result for each preparation stage of CSCF.

FIG. 4A, FIG. 4B, FIG. 4C, FIG. 4D, FIG. 4E, FIG. 4F, FIG. 4G, FIG. 4H, FIG. 4I, FIG. 4J, FIG. 4K, FIG. 4L, FIG. 4M, FIG. 4N, FIG. 4O, and FIG. 4P show FESEM and FESEM-EDS analysis results for each preparation stage of CSCF.

FIG. 5A, FIG. 5B, FIG. 5C, and FIG. 5D are experimental results showing an adsorption performance and a recovery efficiency of the CSCF prepared according to Experimental Example 1.

FIG. 6A, FIG. 6B, FIG. 6C, and FIG. 6D show experimental results indicating a recovery performance depending on a concentration and an adsorption time for each of Nd³⁺ and Dy³⁺ of the NPZIF-8/NaPAF adsorbents prepared according to Experimental Example 1, and show results of introducing each relevant adsorption model so as to interpret these experimental results.

FIGS. 7A and 7B show a comparison of a maximum adsorption amount and a recovery rate constant (k) for each of Nd³⁺ and Dy³⁺ of the NPZIF-8/NaPAF adsorbents prepared according to Experimental Example 1, with those of the best adsorbent in previously reported theses.

FIG. 8A shows a XRD analysis result for a surface of NPZIF-8/NaPAF adsorbents before and after adsorption of Nd³⁺ and Dy³⁺.

FIG. 8B, FIG. 8C, and FIG. 8D are HRTEM grid images of a NPZIF-8 nanoparticle on a surface of CSCF, and show grid images before and after adsorption of the Nd³⁺ and Dy³⁺ ions.

FIG. 9A, FIG. 9B, FIG. 9C, FIG. 9D, FIG. 9E, FIG. 9F, FIG. 9G, and FIG. 9H show TEM-EDS analysis results after adsorption of Nd³⁺ and Dy³⁺ ions.

FIGS. 10A and 10B are experimental results showing a maximum adsorption amount of each of NaPAF, NPZIF-8, and NPZIF-8/NaPAF (CSCF).

FIG. 10C shows a FT-IR analysis result before and after Nd³⁺ and Dy³⁺ adsorption of each of NaPAF, NPZIF-8, and NPZIF-8/NaPAF (CSCF).

FIG. 10D is a reference diagram illustrating an adsorption mechanism of a rare earth metal (REE) from NPZIF-8/NaPAF adsorbents.

FIG. 11A shows an experimental result of measuring a distribution coefficient for each metal ion of NPZIF-8/NaPAF adsorbents in a solution in which Fe²⁺, Nd³⁺, and Dy³⁺ ions coexist.

FIG. 11B shows a change in a compositive ratio of Fe, Nd, and Dy depending on a pH condition.

FIG. 11C shows an experimental result indicating a pressure drop (ΔP) depending on a flow rate of NPZIF-8/NaPAF adsorbents and a NPZIF-8 adsorbent.

FIG. 12A, FIG. 12B, and FIG. 12C are experimental results showing a regeneration characteristic of NPZIF-8/NaPAF adsorbents.

### DETAILED DESCRIPTION OF THE INVENTION

The present invention provides a technology for an adsorbent that not only has an excellent maximum adsorption amount and adsorption rate characteristic for a rare earth metal, but is also easily recoverable in the shape of a fiber having several tens of μm in a diameter.

The adsorbent according to an embodiment of the present invention has a so-called core-shell structure in which a metal-organic framework (MOF) is provided on a polymer fiber. The polymer fiber has several tens of micrometers in a diameter, which increases an easy recovery of the adsorbent, and the metal-organic framework provided on the polymer fiber enables adsorption of the rare earth metal based on a large specific surface area characteristic thereof.

The metal organic framework (MOF) is a porous polymer with a large specific surface area, which has a structure in which a metal is linked by an organic group (linker), and is known to exhibit an excellent property in capturing a gas or a molecule through the large specific surface area (see Patent document 3).

The present invention is applied to adsorption of the rare earth metal from the metal-organic framework.

The large specific surface area of the metal-organic framework enables capture of a metal particle such as the rare earth metal and even a certain level of physical adsorption on a principle similar to trapping of the gas and the molecule, but the metal particle trapped in the metal-organic framework can be easily desorbed from the metal-organic framework, whereby a rate of physical adsorption to the metal-organic framework is limited.

Therefore, in order to ensure that the rare earth metal is stably adsorbed to the metal-organic framework beyond simple capture of the rare earth metal into the metal-organic framework, it is necessary to physiochemically bond the metal-organic framework and the rare earth metal.

The present invention can improve an adsorption characteristic for the rare earth metal by making it possible to capture and absorb the rare earth metal into the metal-organic framework through electrostatic attraction between a functional group formed on the polymer fiber by surface modification and a rare earth metal ion.

In addition, a higher adsorption characteristic for the rare earth metal is realized by the metal-organic framework, which requires to stably bond the metal-organic framework to the polymer fiber, and the functional group formed on the polymer fiber according to the present invention mediates a bonding between the polymer fiber and the metal-organic framework.

In other words, the functional group formed on the polymer fiber by surface modification according to the present invention performs two functions. One is to allow the rare earth metal to be adsorbed into the metal-organic framework through electrostatic attraction with the rare earth metal ion, and the other is to mediate the bond between the polymer fiber and the metal-organic framework to ensure that the metal-organic framework is stably fixed on the polymer fiber.

The functional group formed on the polymer fiber by surface modification is a sodium carboxylate group (—COONa). Further, the polymer fiber having the sodium carboxylate group (—COONa) is sodium polyacrylate (NaPA), and the sodium polyacrylate (NaPA) is formed by surface modification of polyacrylonitrile (PAN).

In addition to the sodium carboxylate group (—COONa), the functional group provided on the polymer fiber may include any one of an amine group (—NH₂), a carboxyl group (—COOH), a hydroxyl group (—OH), a sulfate group (SO₄²⁻), or a phosphate group ([PO₄]³⁻), that can fix a metal ion of a precursor of the metal-organic framework. However, the preferred embodiment is that the sodium carboxylate group (—COONa), which is involved not only in the bond between the polymer fiber and the metal-organic framework but also in the electrostatic attraction with the rare earth metal, is applied as the functional group on the polymer fiber.

A type of the metal-organic framework provided on the polymer fiber is not particularly limited. As described above, since the functional group on the polymer fiber is bonded to the metal ion of the precursor of the metal-organic framework, all the metal-organic frameworks containing the metal ion capable of bonding with the above functional groups can be applied to the present invention. In Experimental Examples described later, ZIF-8 was applied as the metal-organic framework.

A metal-organic framework-polymer fiber-based adsorbent having a core-shell structure according to an embodiment of the present invention has a maximum adsorption amount of 400 mg/g or more for the rare earth metal, and provides an excellent maximum adsorption amount and adsorption rate characteristic by reaching adsorption equilibrium within about 1 minute. In addition, as confirmed in Experimental Examples described later, the adsorbent according to an embodiment of the present invention has a diameter of about 50 m or more and a length longer than the diameter, which results in making recovery of the adsorbent very easy.

For reference, the Patent document 3 suggests a technology relating to a gas sensor coated with ITO and a metal-organic framework on a nanofiber. Since a diameter of the nanofiber formed by electrospinning is a size of nanometer, if this technology is applied for adsorption of the rare earth metal as in the present invention, the nanofiber becomes entangled to reduce a surface area of the adsorbent and make it difficult to control the adsorbent with a fibrous shape in water.

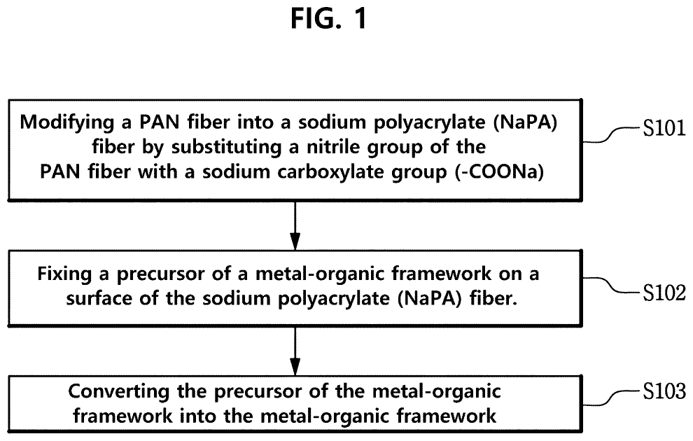

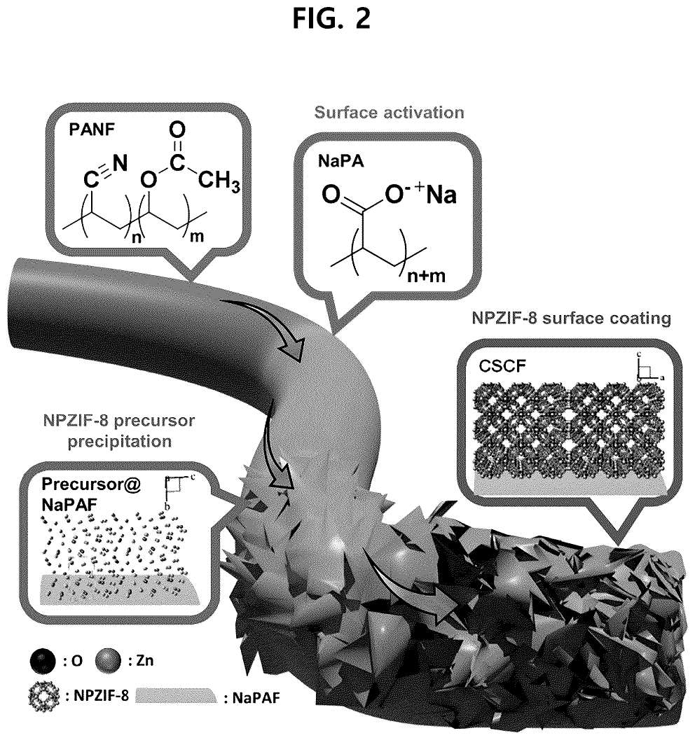

A method for preparing the adsorbent according to an embodiment of the present invention will be described with reference to FIGS. 1 and 2 as follows.

First, surface modification of a polymer fiber is performed (S101). Polyacrylonitrile (PAN) can be used as the polymer fiber. A NaOH solution is prepared, and the polyacrylonitrile (PAN) is immersed in the NaOH solution for a certain period of time to substitute a nitrile group of the polyacrylonitrile (PAN) with a sodium carboxylate group (—COONa). Through this process, the polyacrylonitrile (PAN) is converted to sodium polyacrylate (NaPA), and the sodium carboxylate group (—COONa) is provided on the sodium polyacrylate (NaPA).

Next, a precursor of the metal-organic framework (MOF precursor) is fixed to the surface-modified polymer fiber, that is, the sodium polyacrylate (NaPA) (S102).

Specifically, the sodium polyacrylate (NaPA) is added to a metal solution having a metal dissolved therein, for example, a metal solution having Zn dissolved therein, to adsorb a metal ion on a surface of the sodium polyacrylate (NaPA). In this case, since the surface of sodium polyacrylate (NaPA) is negatively charged by the sodium carboxylate group (—COONa), the metal ion is adsorbed on the surface of sodium polyacrylate (NaPA) due to electrostatic attraction between the sodium carboxylate group (—COONa) and the metal ion, wherein the metal solution exhibits a strong acidity of pH 2 to 4.

The sodium polyacrylate (NaPA) having the metal ion adsorbed therein is taken out from the metal solution and added to an ethanol-based reaction solution (or a methanol-based reaction solution) with a pH of 5 to 12. Due to this, the metal ion adsorbed on the surface of sodium polyacrylate (NaPA) is extracted in the form of metal hydroxide, and the metal hydroxide extracted on the surface of sodium polyacrylate (NaPA) corresponds to a precursor of the metal-organic framework. If a metal solution having Zn dissolved therein is used, the precursor of the metal-organic framework may be Zn₅(OH)₈(NO₃)₂·2H₂O.

In extraction of the metal-organic framework precursor on the surface of sodium polyacrylate (NaPA), in case a hydrochloric acid is used as a reaction solution in addition to the ethanol-based reaction solution (or the methanol-based reaction solution), extraction of the metal hydroxide rarely occurs, and in case a distilled water is used as the reaction solution, a certain amount of the metal hydroxide is extracted, but it is difficult for a crystal to be fixed on the surface because a moisture content is higher to cause a large diameter of the fiber. On the other hand, in case the ethanol-based reaction solution is used, extraction of the metal hydroxide becomes significantly superior, which can be confirmed through the experimental results described later.

A precursor of the metal organic framework is converted into the metal organic framework (MOF) while the precursor of the metal organic framework is formed on a surface of sodium polyacrylate (NaPA) (S103). Specifically, the sodium polyacrylate (NaPA) fixed by the precursor of the metal-organic framework is added to an organic ligand solution, and then is stirred to convert the precursor of the metal-organic framework into the metal-organic framework (MOF). In this case, a solution containing the organic ligand that can react with the precursor of the metal-organic framework to form the metal-organic framework (MOF) is used as an organic ligand solution. As an example, an adsorbent in which ZIF-8 as the metal-organic framework is fixed to the sodium polyacrylate (NaPA) may be prepared through the above process by using 2-methyl imidazole (mIm) as the organic ligand.

The adsorbent prepared according to the present invention, that is, the metal-organic framework-polymer fiber-based adsorbent having the core-shell structure has a high adsorption selectivity for the rare earth metal. In other words, it exhibits an excellent adsorption selectivity for the rare earth metal under an environment where various metals, including the rare earth metal, coexist.

Referring to the experimental results described later, in a solution having Fe²⁺, Nd³⁺, and Dy³⁺ dissolved together, an adsorption amount of the adsorbent of the present invention for Nd³⁺ and Dy³⁺ is more than 100 times higher than an adsorption amount of Fe²⁺. Specifically, as a result of calculating a distribution coefficient (Kd, mg/L), which indicates the adsorption selectivity of the adsorbent of the present invention for a specific ion, for each Fe and rare earth metal ion, the distribution coefficient values tended to be in the order of magnitude: Fe³⁺ (1.6×10³ mg·L⁻¹)<<Dy³⁺ (2.0×10⁵ mg·L⁻¹)≤Nd³⁺ (6.3×10⁵ mg·L⁻¹)⁺. This order is assumed to be related to a size of the ionic radius. It is difficult for a Fe ion having the largest ionic radius to enter a grid of the metal-organic framework and be adsorbed to the grid, but a relatively small rare earth metal ion is believed to be easily adsorbed by forming a chemical bond within the grid of the metal-organic framework.

As such, the adsorbent according to the present invention has an adsorption selectivity of 100 times or more for the rare earth metal, and yet, in order to adsorb the rare earth metal more selectively under an environment where various metals coexist, it is possible to apply a process of extracting the remaining metals in advance, excluding the rare earth metal.

As an example, if a waste permanent magnet of Nd—Fe—B series consisting of Fe, Nd, and Dy is added to a strong acid solution of pH 2 or less, all the Fe, Nd, and Dy components are dissolved, and then if a pH of the solution is adjusted to 4 or more, the Fe component is precipitated by extraction. In this situation, if the Nd and Dy components are recovered using the adsorbent according to the present invention, a recovery efficiency for the rare earth metal can be further increased. In this regard, referring to the experimental results described later, when the waste permanent magnet consisting of 65 wt % Fe, 25 wt % Nd, and 10 wt % Dy was dissolved, it can be seen that initial compositions of Fe, Nd and Dy are maintained at a pH of 1 to 2 without any change, a composition of Fe decreases to 43 wt % at a pH of 3, and then all Fe in the solution is precipitated at a pH of 4 or higher by extraction.

As described above, a metal-organic framework-polymer fiber-based adsorbent having a core-shell structure and a method for preparing the adsorbent, and a method for recovering a rare earth metal using the same were described according to an embodiment of the present invention. Hereinafter, the present invention will be described in more detail through Experimental Examples.

### Experimental Example 1: Preparation of NPZIF-8/NaPAF Adsorbents

A commercial PAN fiber with a diameter of 50 m was immersed in an ethanol solution having NaOH dissolved therein, and then maintained at a temperature of 75° C. for 48 hours in maximum to modify a surface of the PAN fiber. The surface modified NaPA fiber was put into an ethanol solution having Zn dissolved therein to adsorb a Zn metal ion on the surface of the NaPA fiber. Next, the NaPA fiber with the Zn metal ion adsorbed was put into an ethanol reaction solution whose pH was adjusted between 5 and 12 to extract the Zn metal ion as Zn₅(OH)₈(NO₃)₂·2H₂O on the surface of the NaPA fiber. Then, the NaPA fiber was reacted with a ligand solution to form ZIF-8 on the NaPA fiber.

In order to compare a formation efficiency of the ZIF-8 depending of the reaction solution, the above preparation process was performed using a hydrochloric acid and a distilled water instead of the ethanol solution as the reaction solution, respectively.

### Experimental Example 2: Surface Modification Characteristic

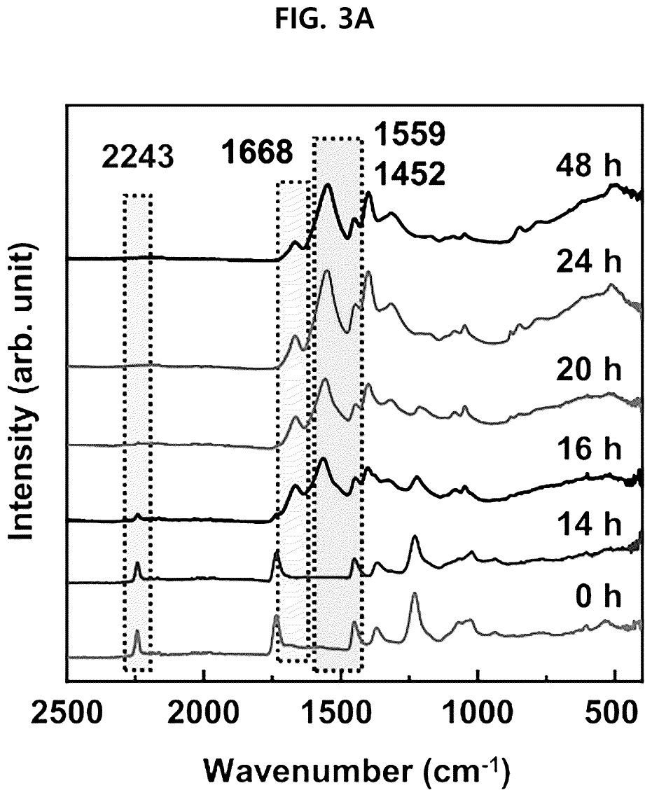

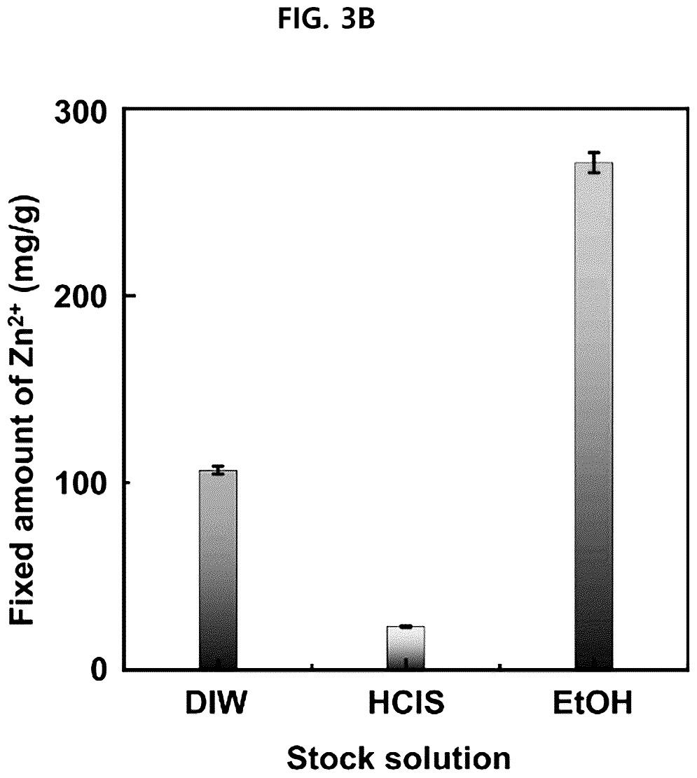

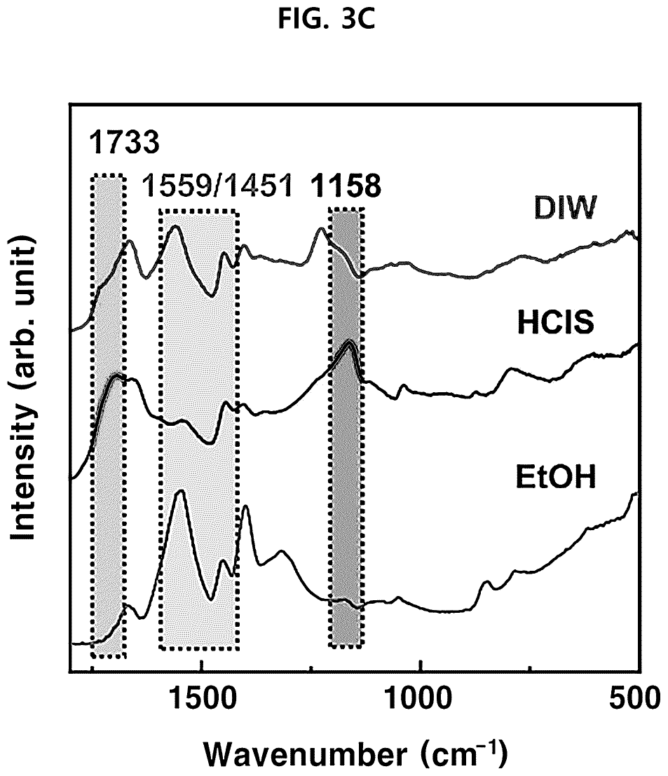

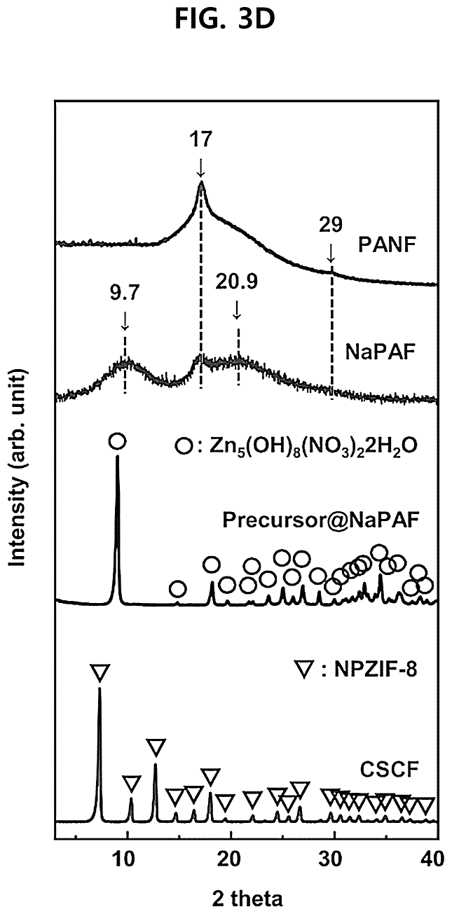

In the preparation of the NaPA fiber according to Experimental Example 1, it was examined that a nitrile group of the PAN was substituted with a sodium carboxylate group (—COONa) depending on an immersion time in a NaOH solution. As shown in FIG. 3A, it can be seen that a peak for the nitrile group of the PAN fiber completely disappears at 2243 cm⁻¹ from the point of time 20 hours lapse.

### Experimental Example 3: Formation Characteristic of ZIF-8 Depending on a Reaction Solution

In adsorption of the Zn ion into the NaPA fiber according to Experimental Example 1, it was confirmed that an adsorption efficiency of the Zn metal ion varied depending on a type of the reaction solution. Referring to FIG. 3B, in case ethanol was applied as the reaction solution, about 271 mg/g of the Zn ion was adsorbed, whereas in case a hydrochloric acid was applied, about 23 mg/g of the Zn ion was adsorbed, and in case a distilled water was applied, about 106 mg/g of the Zn metal ion was adsorbed.

In addition, as a result of the FT-IR analysis, as shown in FIG. 3C, in case the ethanol reaction solution was applied, a clear peak appeared at 1559/1451 cm⁻¹ corresponding to a —COONa functional group in the NaPA fiber, whereas in case the hydrochloric acid was applied, the peak appeared at 1158 and 1733 cm⁻¹ corresponding to —COOH, and in case the distilled water was applied, the two functional groups appeared to coexist. This result means that the —COONa functional group is advantageous for fixing the Zn ion, which is a precursor of NPZIF-8, and that the ethanol is most suitable to maintain this functional group.

As a result of carrying out the XRD analysis for each preparation stage on the adsorbent in which the ZIF-8 nanoparticle (NPZIF-8) was formed on the NaPA fiber (NaPAF) according to Experimental Example 1, that is, the CSCF (Core/shell synergistic composite fiber), as shown in FIG. 3D, it can be confirmed that a structural change (NaPAF) in a polymer chain occurred due to surface modification of the PAN fiber (PANF), and Zn₅(OH)₈(NO₃)₂2H₂O, a precursor of NPZIF-8, can be confirmed to be suitably formed on a surface of the NaPA fiber (NaPAF) to form the CSCF ultimately coated with the NPZIF-8 nanoparticle.

In case the CSCF was prepared according to Experimental Example 1 by applying each reaction solution, the FESEM and FESEM-EDS analyses were performed for each preparation stage.

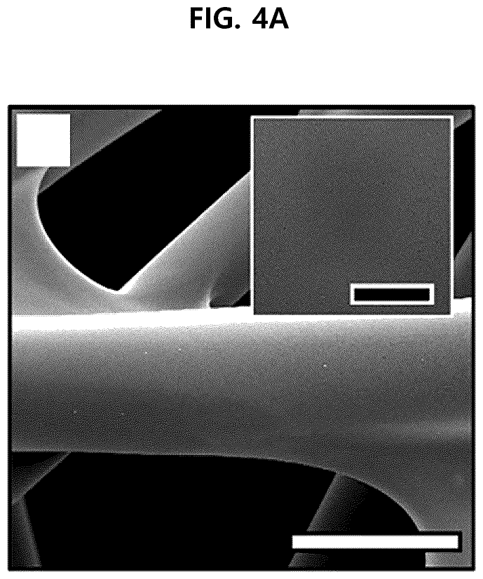

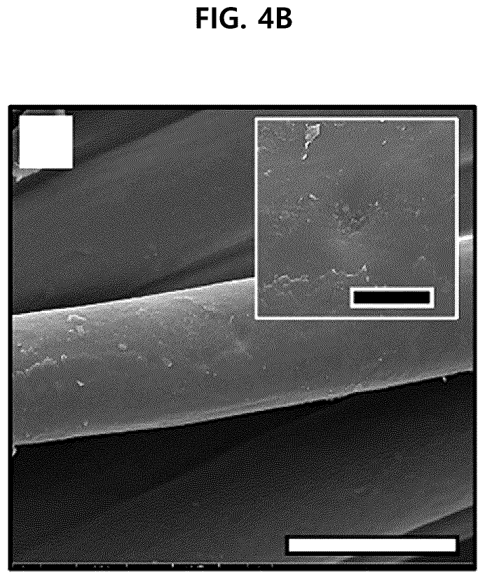

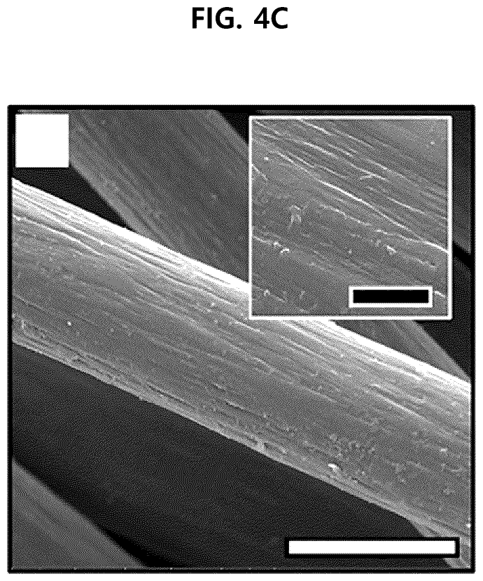

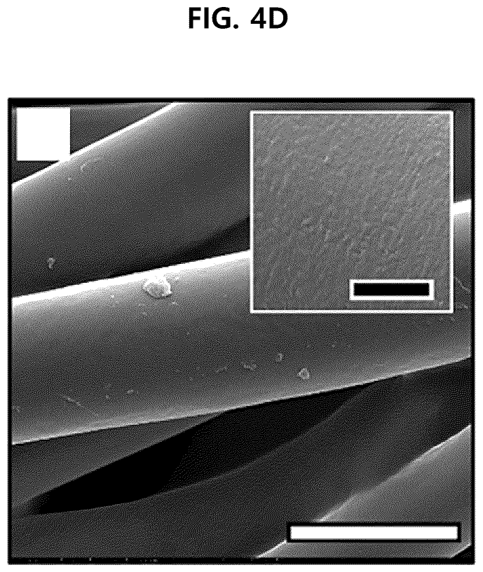

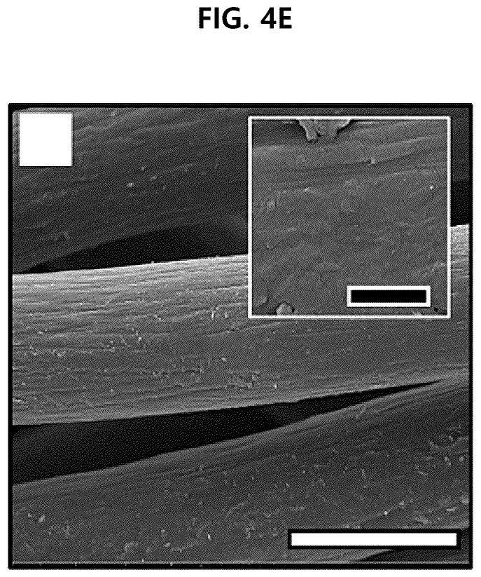

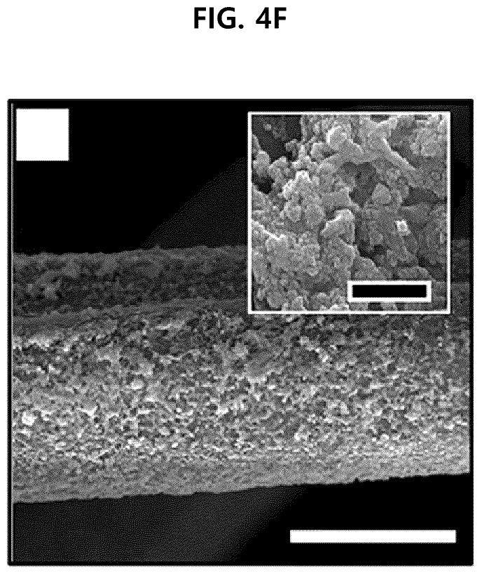

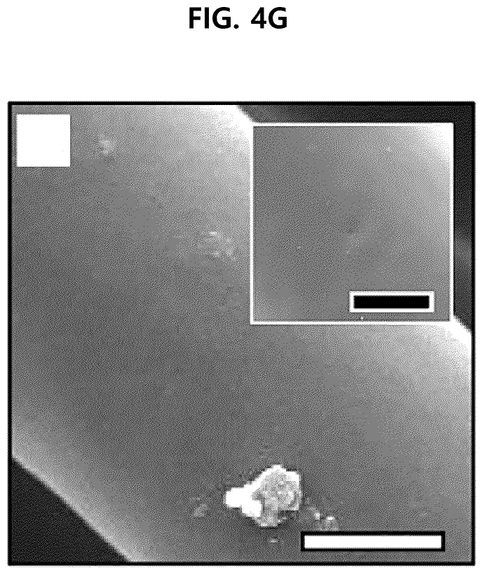

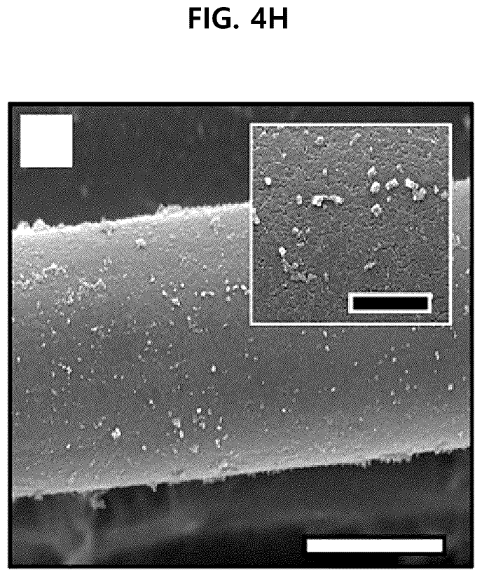

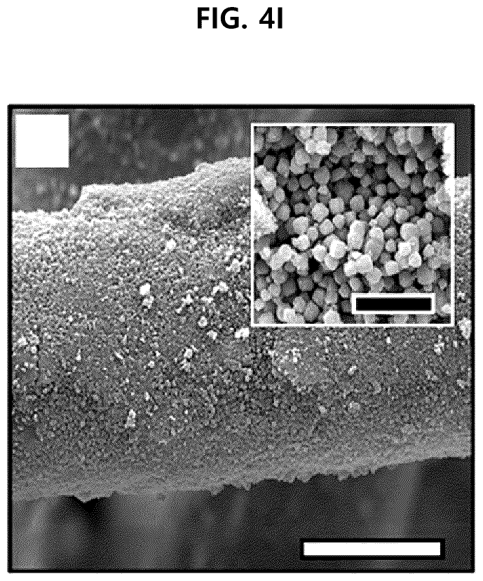

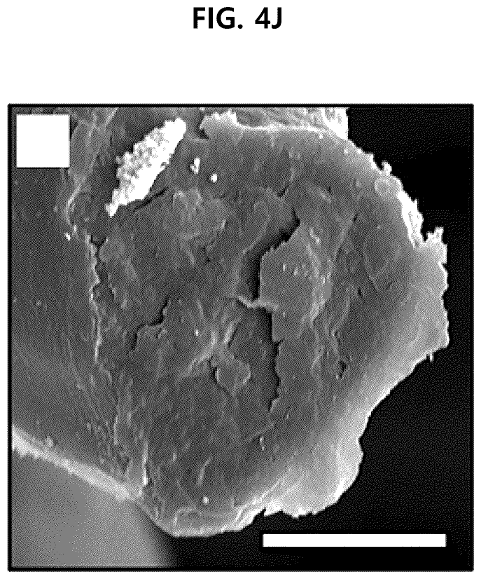

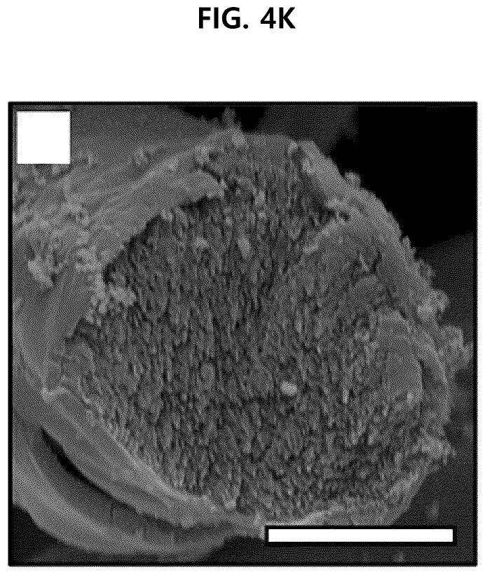

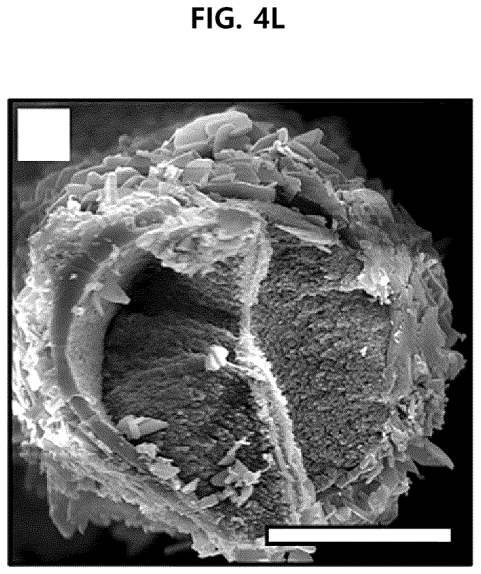

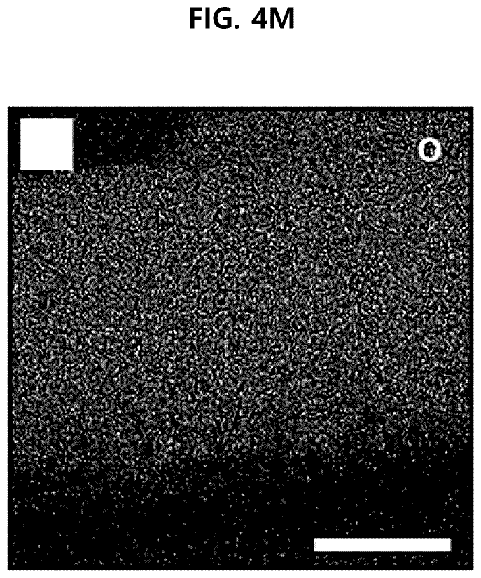

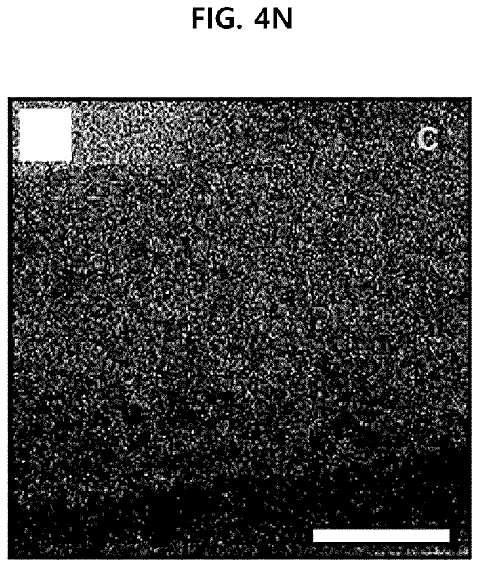

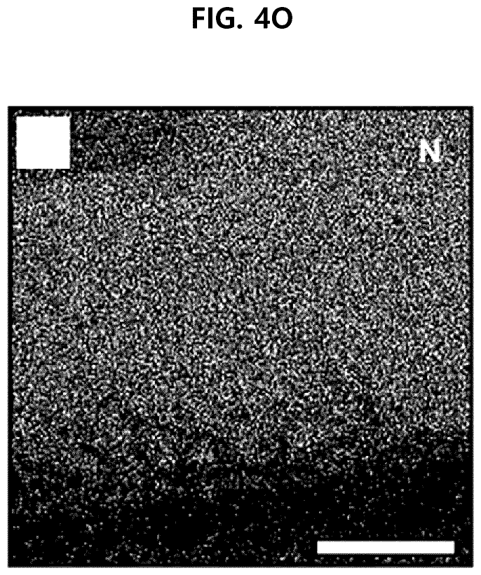

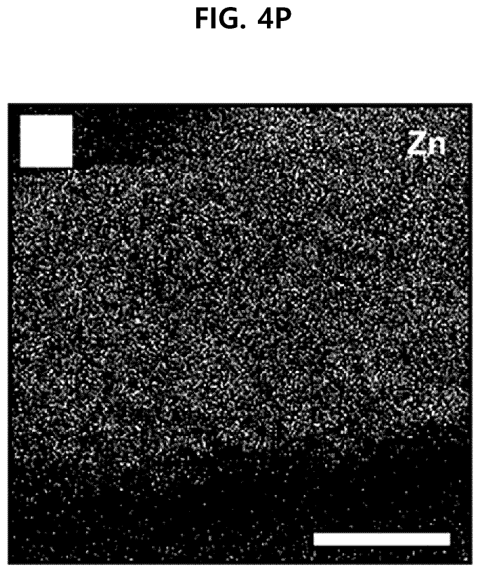

Each of FIGS. 4D to 4F is FESEM images taken to confirm a formation state of Zn₅(OH)₈(NO₃)₂2H₂O when a distilled water, a hydrochloric acid, and ethanol were applied as the reaction solution, respectively. Each of FIGS. 4G to 4I is FESEM images taken to confirm a formation state of NPZIF-8 when the distilled water, the hydrochloric acid, and the ethanol were applied as the reaction solution, respectively. In addition, each of FIGS. 4J to 4L is FESEM images for a cross section of the CSCF prepared by applying the distilled water, the hydrochloric acid, and the ethanol as the reaction solution, respectively. As confirmed by FIGS. 4D to 4L, when the ethanol was applied as the reaction solution, it can be seen that the NPZIF-8 precursor and the NPZIF-8 nanoparticle were stably formed on the NaPA fiber. This result is also consistent with the FESEM-EDS analysis result. FIGS. 4M to 4P are the FESEM-EDS analysis results for FIG. 4I, which shows that the NPZIF-8 nanoparticle is uniformly formed on a surface of the NaPA fiber.

On the other hand, it can be seen that in case the hydrochloric acid was applied, the NPZIF-8 precursor and the NPZIF-8 nanoparticle were formed in a small amount, and in case the distilled water was applied, NPZIF-L in the shape of a leaf, not the NPZIF-8 nanoparticle, was formed. For reference, each of FIGS. 4A to 4C is FESEM images of the NaPA fiber taken to surface modify the PAN fiber and then wash away NaOH remaining on the surface of the NaPA fiber with the distilled water, the hydrochloric acid, and the ethanol, respectively.

### Experimental Example 4: Adsorption Characteristic of a Rare Earth Metal in NPZIF-8/NaPAF Adsorbents

Ethanol was applied as a reaction solution to analyze an adsorption performance of CSCF, that is, NPZIF-8/NaPAF adsorbents prepared according to Experimental Example 1, for Nd³⁺ and Dy³⁺ at each pH condition.

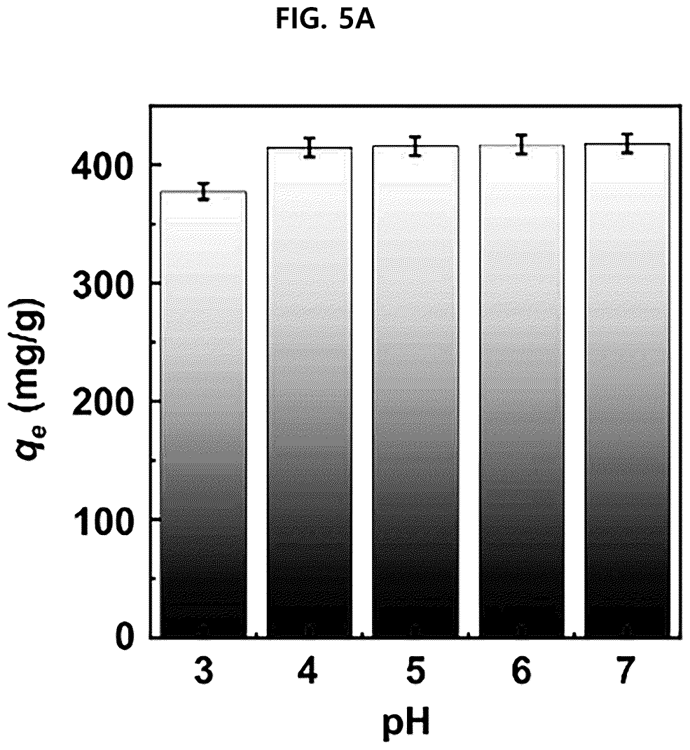

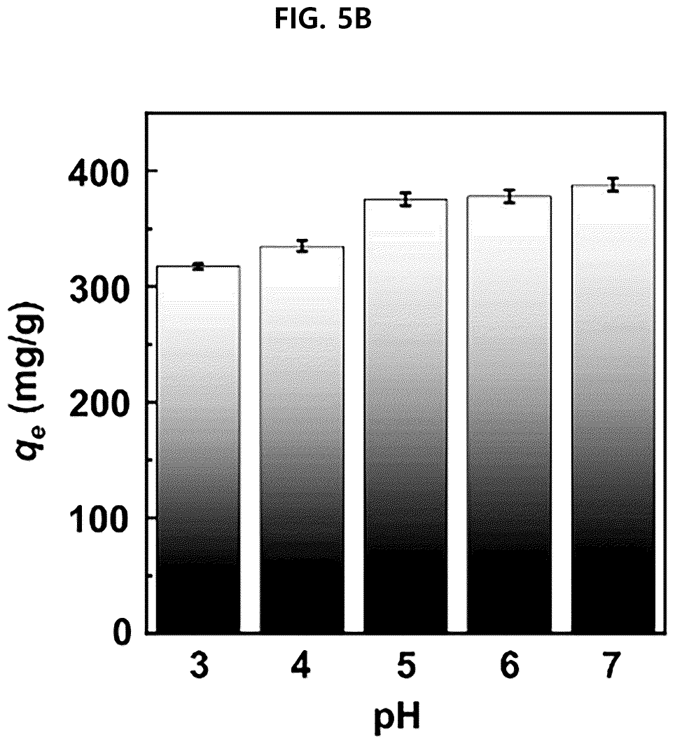

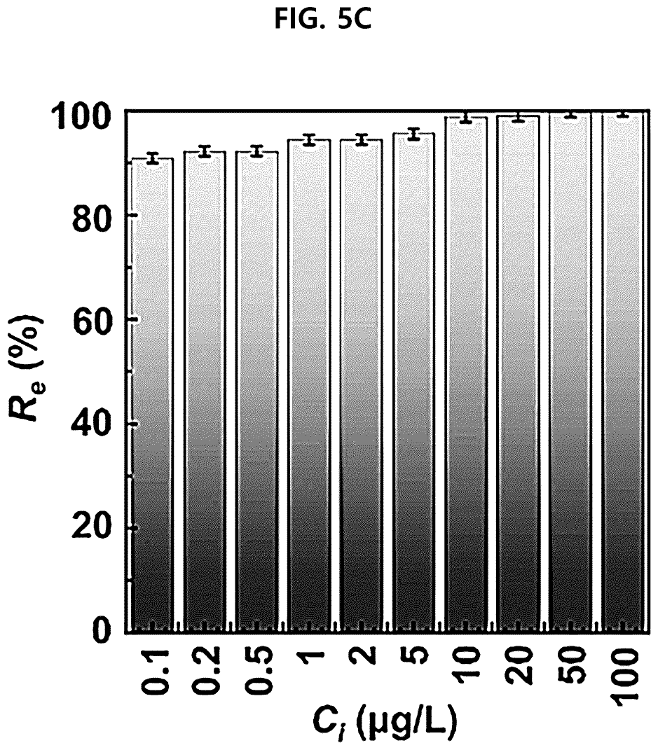

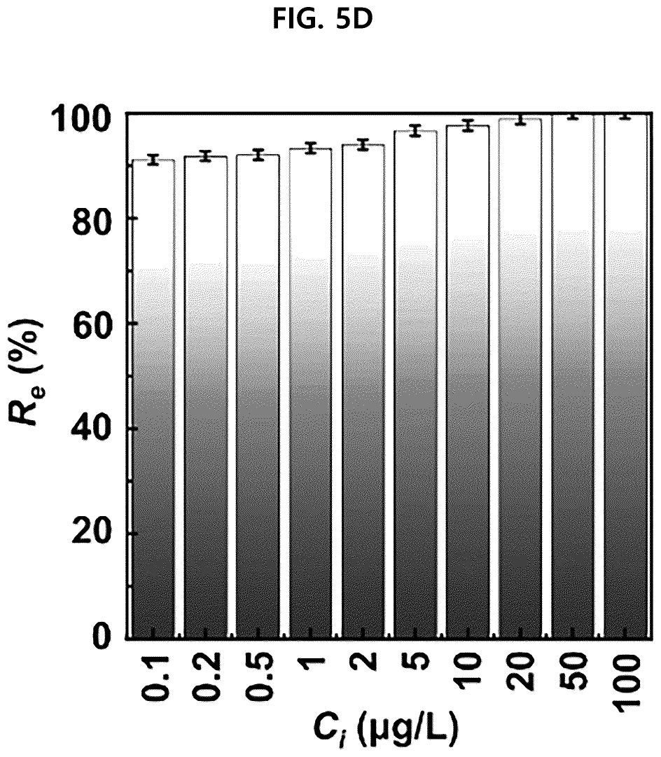

FIG. 5A is the result of an isothermal adsorption experiment according to pH condition for Nd³⁺, and FIG. 5B is the result of an isothermal adsorption experiment according to pH condition for Dy³⁺. Referring to FIGS. 5A and 5B, excellent adsorption performance of 370 mg/g or more and 310 mg/g or more for Nd³⁺ and Dy³⁺, respectively, was shown at a pH of 3 to 7. However, they showed better adsorption characteristic under the condition of a pH 4 or higher.

Further, referring to FIGS. 5C (Nd³⁺) and 5D (Dy³⁺), it can be confirmed that a recovery efficiency was 90% or more under the condition where a concentration of Nd³⁺ and Dy³⁺ was 0.1 μg/L or more, and that as a concentration of the rare earth metal increased, the recovery efficiency reached 100%.

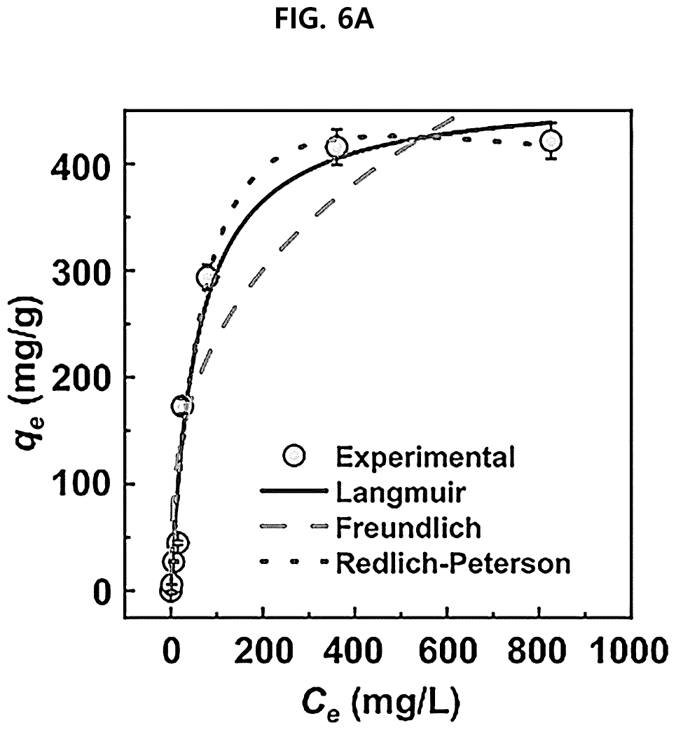

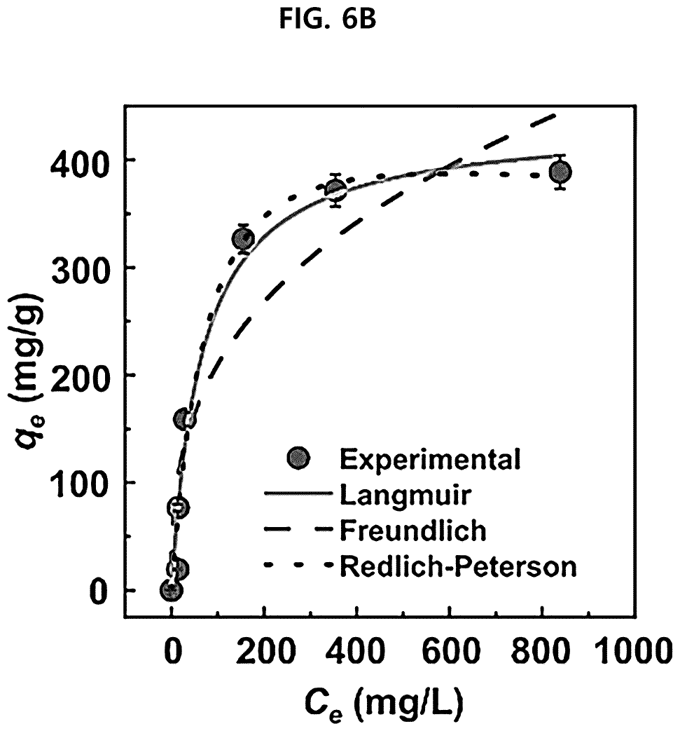

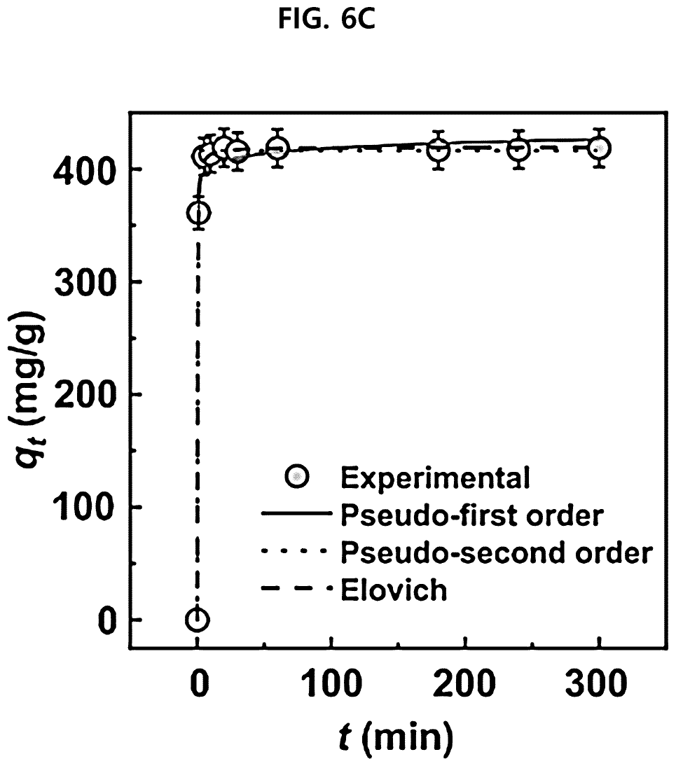

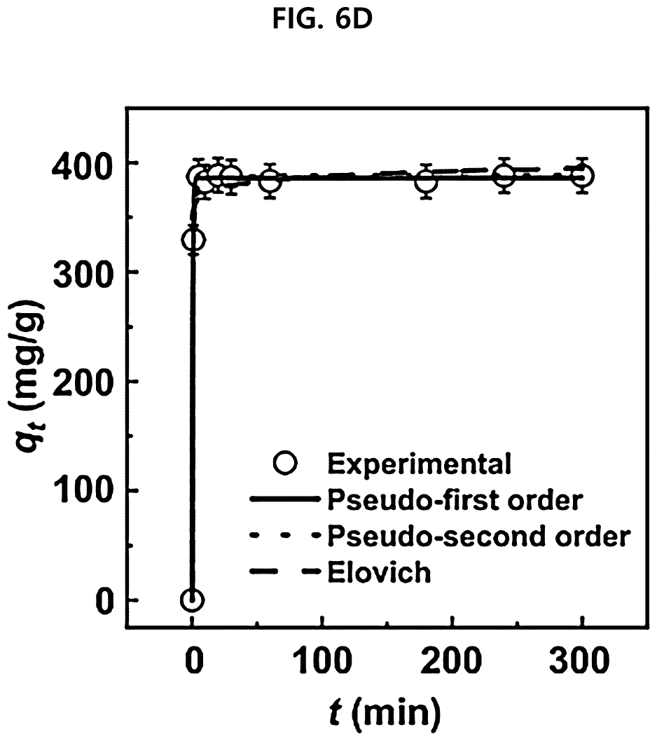

FIGS. 6A to 6D show experimental results indicating a recovery performance depending on a concentration and adsorption time for each of Nd³⁺ and Dy³⁺ of the NPZIF-8/NaPAF adsorbents prepared according to Experimental Example 1, and show results of introducing each relevant adsorption model so as to interpret these experimental results. Referring to FIGS. 6A to 6D, for the two rare earth metals, a trend of the recovery performance depending on the concentration was most similar to the Langmuir and Redlich-Peterson model (coefficient of determination R²=−1). From the above, it can be inferred that a surface of the adsorbent is uniformly coated with a ZIF-8 nanoparticle, and it can be seen that the rare earth metals are simultaneously adsorbed to the ZIF-8 on a surface of the material. Adsorption data depending on the adsorption time showed that the two rare earth metals reached adsorption equilibrium within 2 minutes, and the results of applying these results to three models showed the highest consistence with the pseudo-first-order model and the pseudo-second-order model (R²=1.00). A rate of reaching the adsorption equilibrium was so fast that it was not possible to determine which of the two models was more consistent. However, from these results, it can be inferred that the rate-limiting step in the recovery process was the adsorption step by chemical bonding.

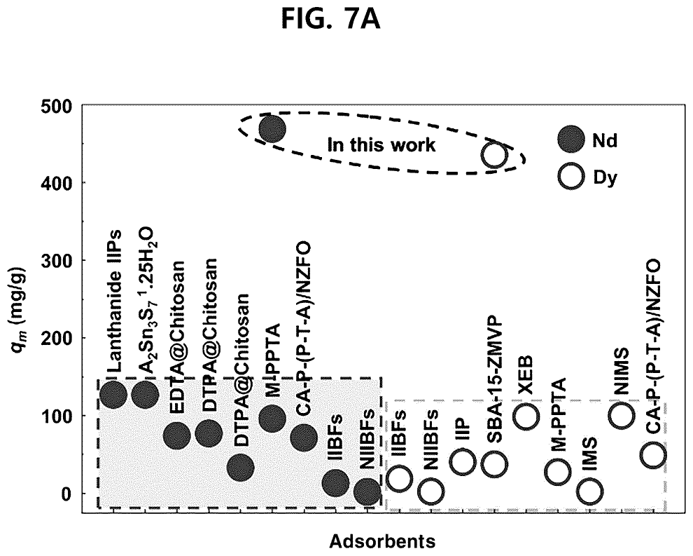

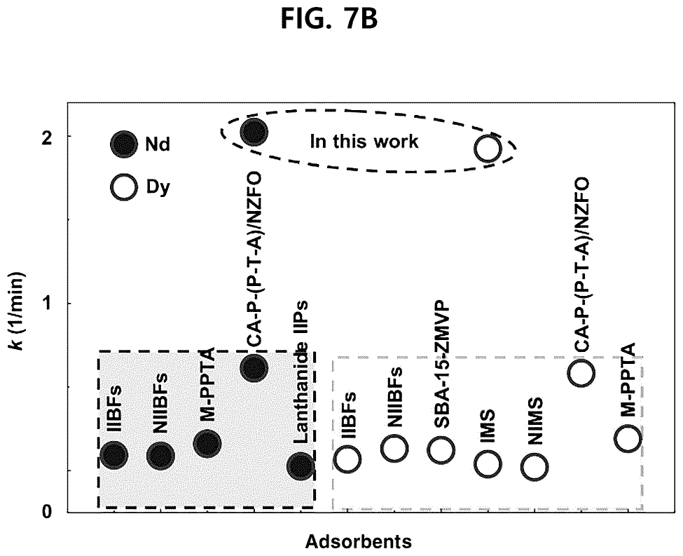

FIGS. 7A and 7B each show a comparison of a maximum adsorption amount and a recovery rate constant (k) for each of Nd³⁺ and Dy³⁺ of the NPZIF-8/NaPAF adsorbents prepared according to Experimental Example 1, with those of the best adsorbent in previously reported theses. While the maximum adsorption amount and the recovery rate constant (k) of the best adsorbent in the previously reported theses are 150 mg/g or less and 1 or less, respectively, the NPZIF-8/NaPAF adsorbents have the maximum adsorption amount of 400 mg/g or more and the recovery rate constant (k) close to 2. Accordingly, it can be seen that the maximum adsorption amount and recovery rate constant (k) characteristics for Nd³⁺ and Dy³⁺ are remarkably excellent.

The Nd³⁺ and Dy³⁺ adsorption characteristics of the NPZIF-8/NaPAF adsorbents can also be confirmed through the XRD, HRTEM and TEM-EDS analysis results.

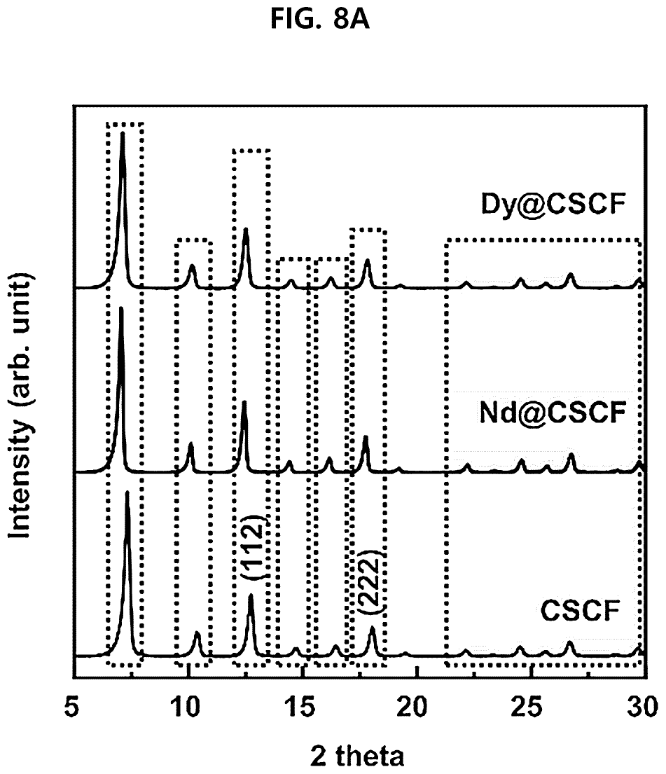

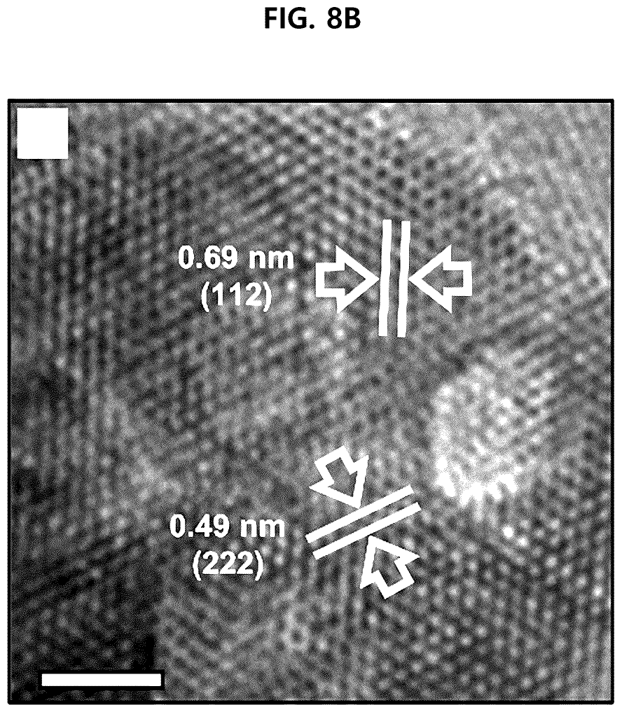

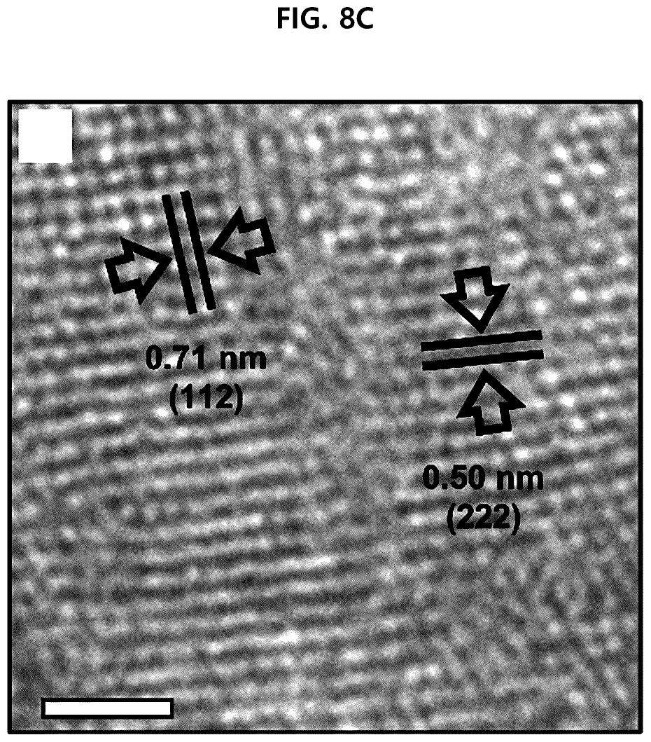

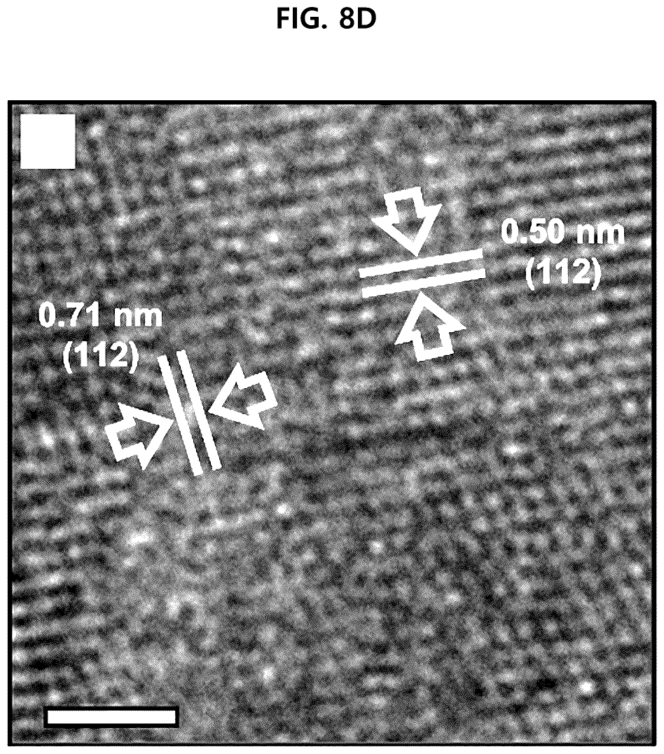

FIG. 8A shows the XRD analysis result for a surface of the NPZIF-8/NaPAF adsorbents before and after Nd³⁺ and Dy³⁺ adsorption. Considering that peaks with 20 values of less than 30 move to higher 20 after the adsorption, it is judged that the rare earth metal has entered between relatively wide crystal planes.

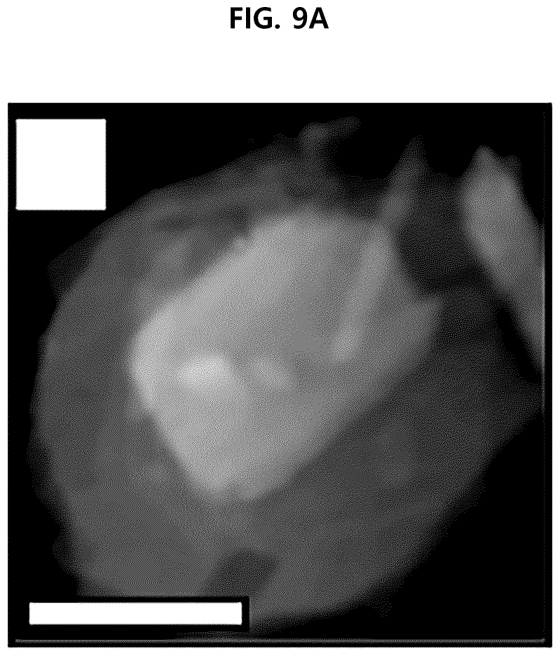

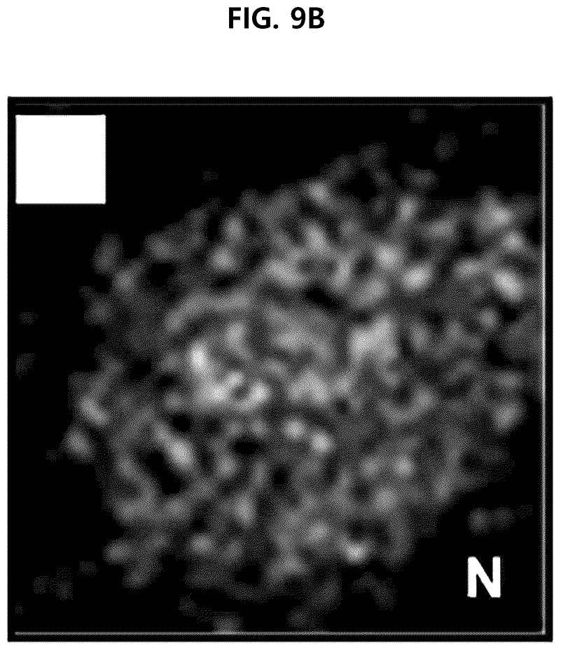

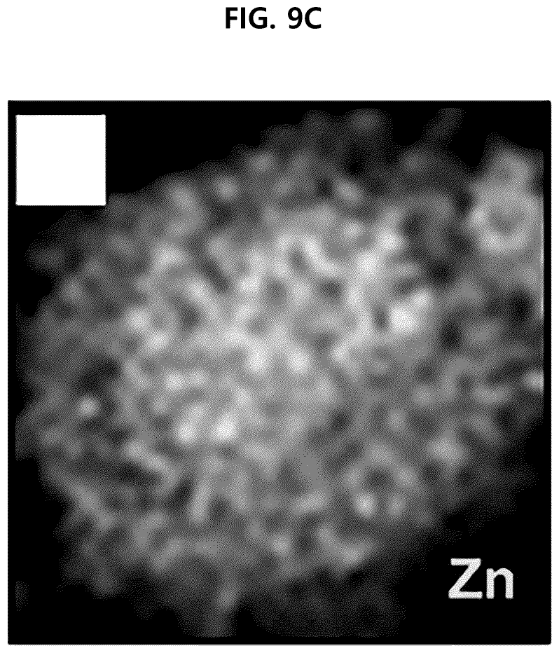

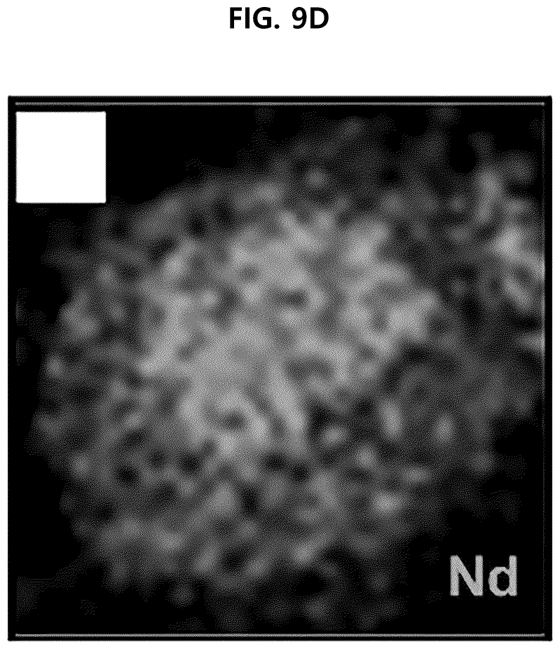

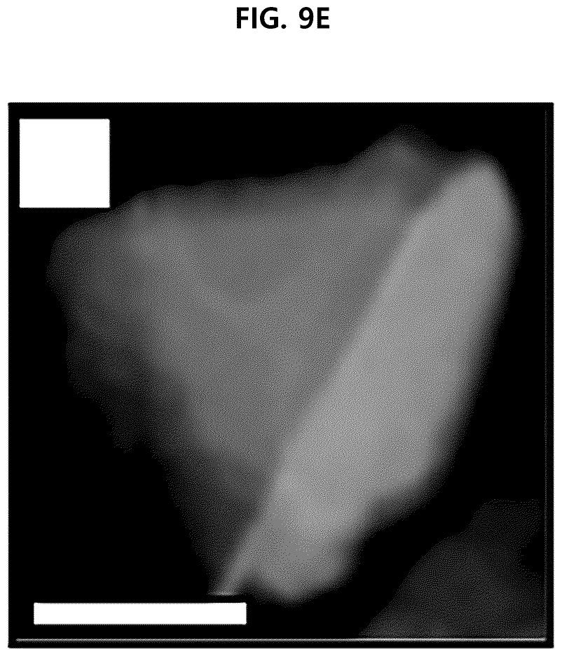

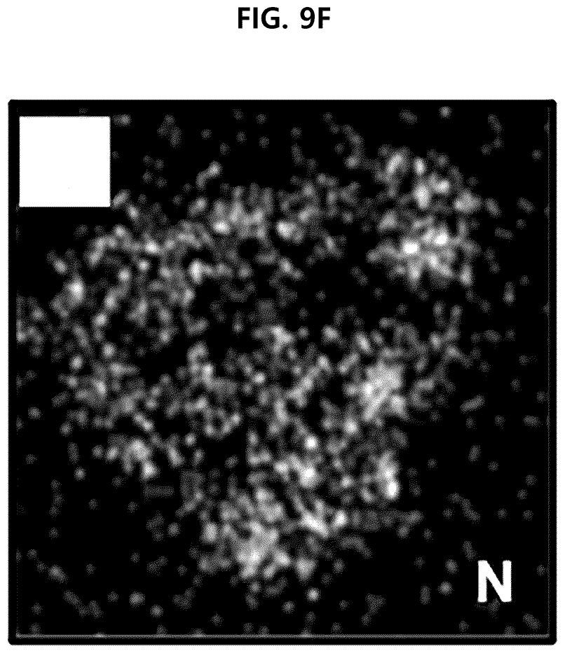

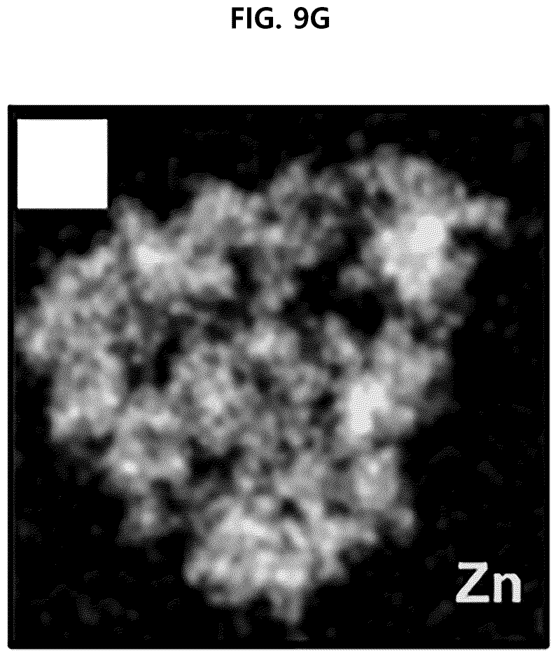

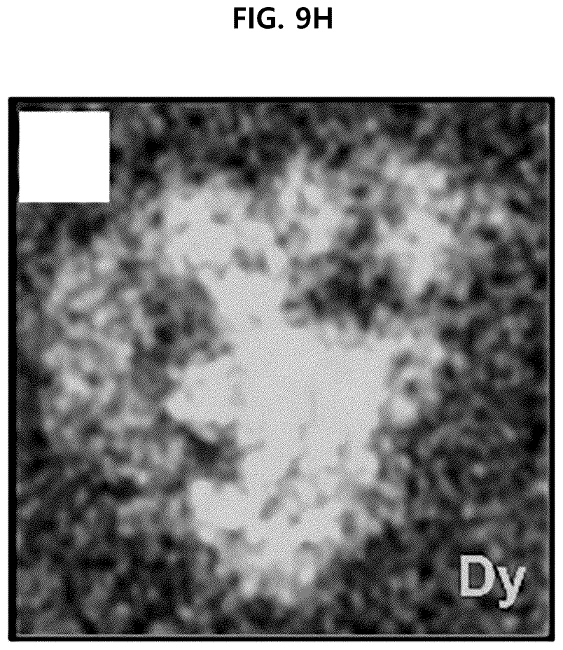

FIG. 8B is a HRTEM grid image of the NPZIF-8 nanoparticle on a surface of CSCF, showing (112) and (222) planes with grid intervals of 0.69 nm and 0.49 nm, and FIGS. 8C and 8D are HRTEM images showing increase in the intervals between the crystals after adsorption of Nd³⁺ and Dy³⁺ ions, respectively. FIGS. 9A to 9D are TEM-EDS analysis results for FIG. 8C, and FIGS. 9E to 9H are TEM-EDS analysis results for FIG. 8D, showing that Nd³⁺ and Dy³⁺ ions are evenly distributed within a grid of the NPZIF-8 nanoparticle.

### Experimental Example 5: Adsorption Characteristic of NaPAF, NPZIF-8, and NPZIF-8/NaPAF

In order to examine an effect of NaPAF and NPZIF-8 on the adsorption characteristic of NPZIF-8/NaPAF adsorbents, a maximum adsorption amount and an adsorption rate characteristic were analyzed for NaPAF, NPZIF-8, and NPZIF-8/NaPAF (CSCF), respectively.

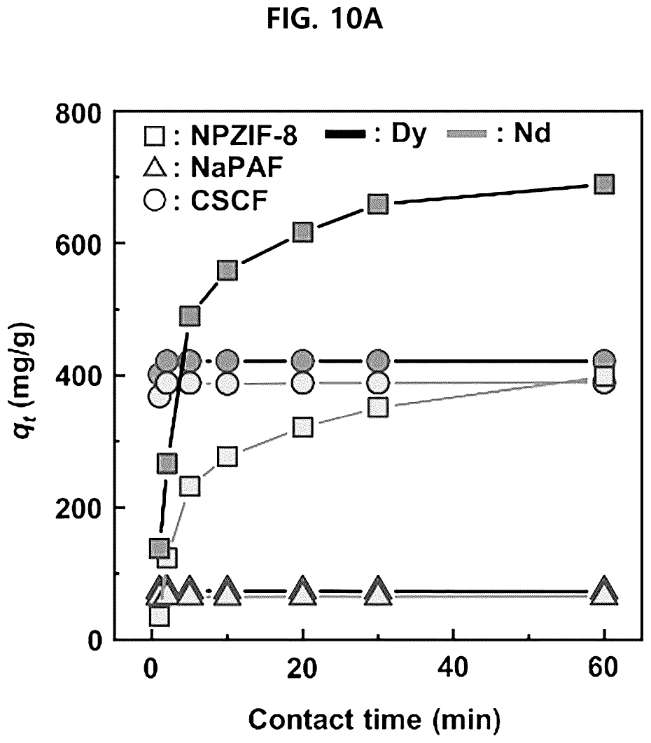

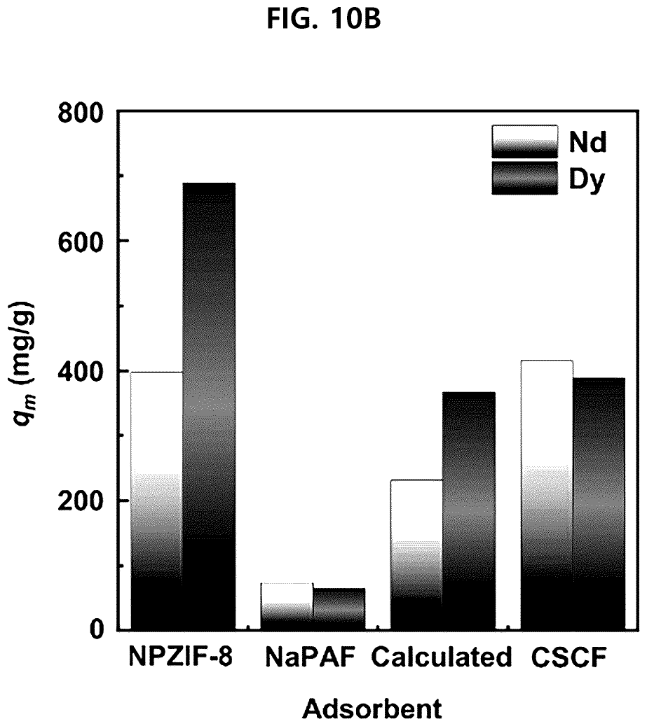

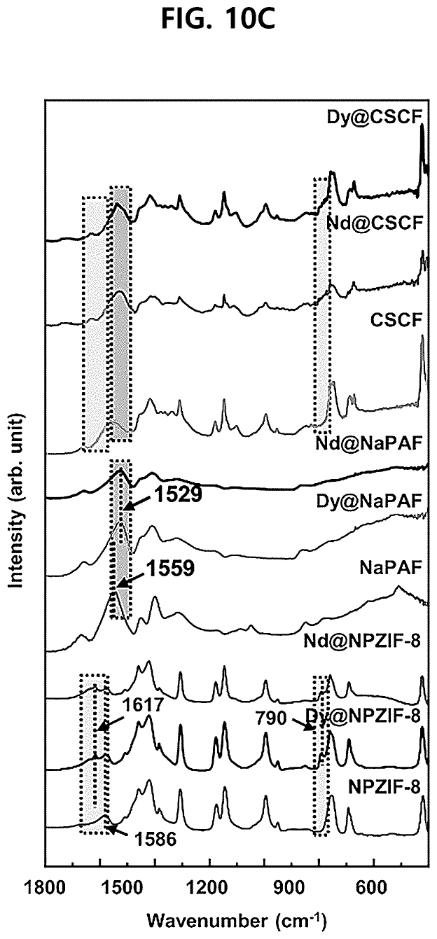

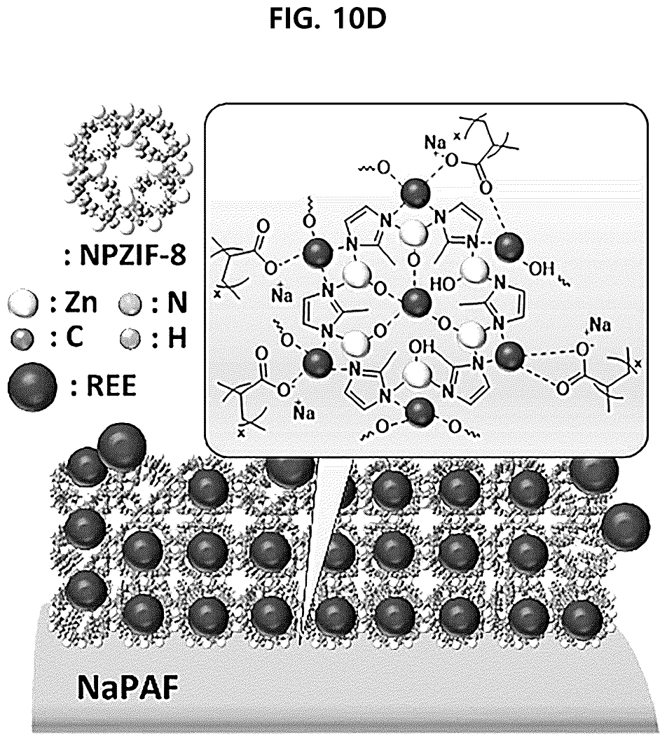

Referring to FIGS. 10A and 10B, in the case of the NaPAF, the maximum adsorption amount for Nd³⁺ and Dy³⁺ was small as 100 mg/g or less, but a time to reach adsorption equilibrium was very fast as 1 minute or less. The NPZIF-8 had a very large maximum adsorption amount exceeding 400 mg/g for both Nd³⁺ and Dy³⁺, but took 1 hour or more to reach the adsorption equilibrium. On the other hand, in the case of the NPZIF-8/NaPAF (CSCF), the adsorbent of the present invention, the adsorption equilibrium was reached within 1 minute and the maximum adsorption amount indicated 400 mg/g or more for both Nd³⁺ and Dy³⁺, which confirms that the maximum adsorption amount and the adsorption rate are all excellent.

What is interesting from the above experimental results is that the maximum adsorption amount of the NPZIF-8/NaPAF (CSCF) for Nd³⁺ and Dy³⁺ exceeds the value calculated by simulation (simulated CSCF). The simulated CSCF is calculated by multiplying a weight ratio of the NaPAF and the NPZIF-8 by the maximum adsorption amount of the NaPAF and the NPZIF-8, respectively. As shown in FIG. 10B, it can be seen that the numerical value of the maximum adsorption amount of the NPZIF-8/NaPAF (CSCF) for Nd³⁺ and Dy³⁺ exceeds that of the simulated CSCF. This is interpreted to mean that the adsorption characteristics of each NaPAF and NPZIF-8 are increased due to their combination.

FIG. 10C shows a FT-IR analysis result before and after Nd³⁺ and Dy³⁺ adsorption of each of NaPAF, NPZIF-8, and NPZIF-8/NaPAF (CSCF), and FIG. 10D is a reference diagram illustrating an adsorption mechanism of a rare earth metal (REE) from NPZIF-8/NaPAF adsorbents. Referring to the FT-IR analysis result in FIG. 10C and the adsorption mechanism in FIG. 10D, it can be seen that the NaPAF induces movement of the rare earth metal ions (Nd³⁺, Dy³⁺) to a surface of the NPZIF-8/NaPAF adsorbents, and that the NPZIF-8 effectively adsorbs the rare earth metal ions by utilizing its high specific surface area and chemical functional group.

### Experimental Example 6: Adsorption Selectivity and Regeneration Characteristic of NPZIF-8/NaPAF Adsorbents

In order to examine an adsorption selectivity of NPZIF-8/NaPAF adsorbents for a rare earth metal, a distribution coefficient for each metal ion of the NPZIF-8/NaPAF adsorbents was measured and calculated in a solution where Fe²⁺, Nd3⁺, and Dy³⁺ ions coexist.

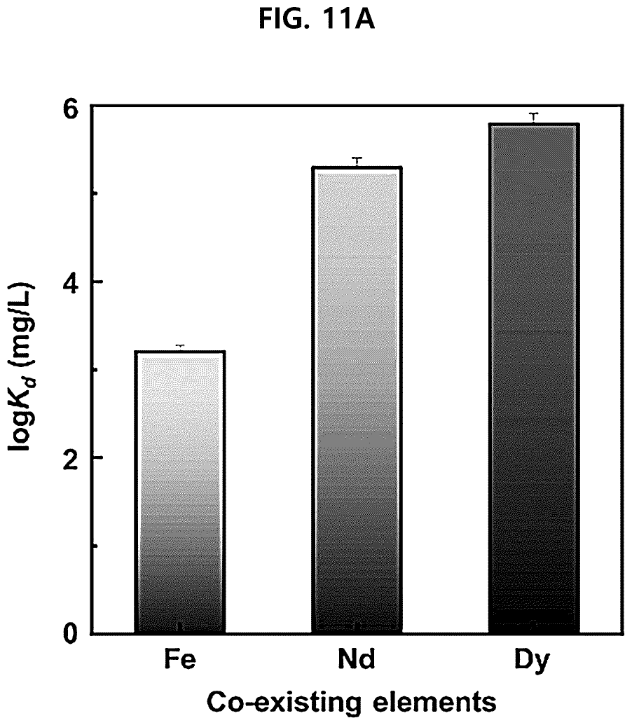

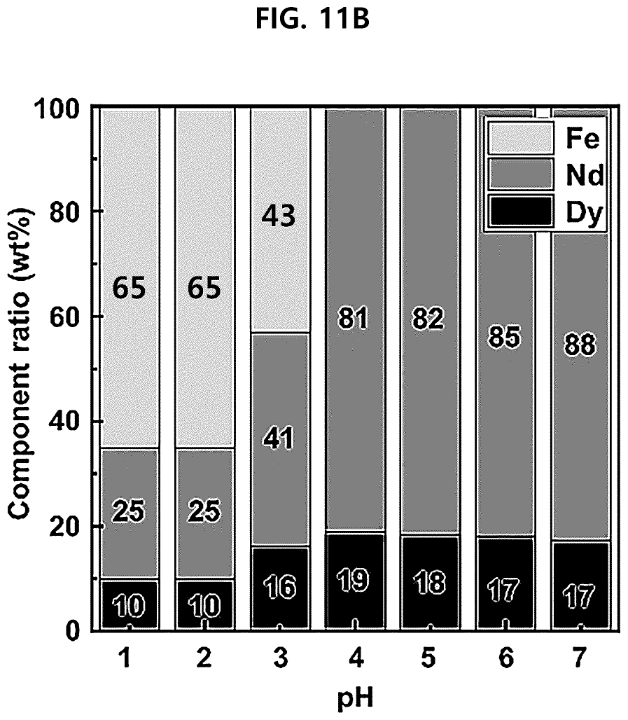

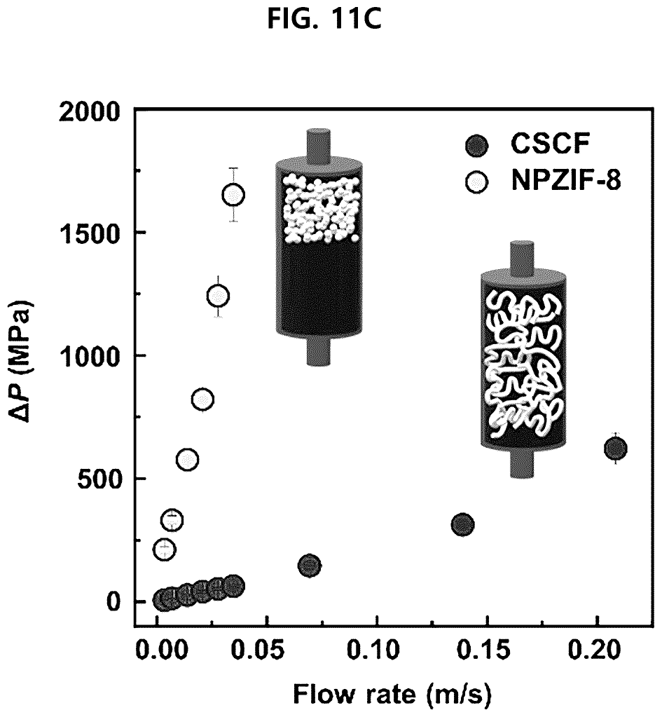

It was calculated that the distribution coefficient (Kd) for Fe²⁺ is 1.6×10³ mg·L⁻¹, whereas the distribution coefficients (Kd) for Nd³⁺ and Dy³⁺ are 6.3×10⁵ mg·L⁻¹ and 2.0×10⁵ mg·L⁻¹, respectively (see FIG. 11A). This means that a maximum adsorption amount for each of Nd³ and Dy³⁺ is more than 100 times compared to that of Fe²⁺.

Further, an additional experiment was conducted to support the fact that the rare earth metal can be recovered more effectively from a waste permanent magnet. As is known, the permanent magnet of Nd—Fe—B series consists of approximately 65 wt % of Fe, 25 wt % of Nd, and 10 wt % of Dy, but such a composition was confirmed to change depending on a pH condition. FIG. 11B shows a change in a compositive ratio of Fe, Nd, and Dy depending on the pH condition. The compositive ratio of Fe 65 wt %, Nd 25 wt %, and Dy 10 wt % is maintained under a condition of pH 1 to 2, but it can be confirmed that under a condition of pH 3 or higher, specially under a condition of pH 4 or higher, all Fe is precipitated by extraction and only a compound consisting of Nd and Dy exists.

Since the NPZIF-8/NaPAF adsorbents of the present invention is in the shape of a fiber with a diameter of 50 μm, it exhibits a lower pressure drop characteristic compared to the adsorbent in the form of a nanoparticle when actually applied to an adsorption reaction tank. FIG. 11C shows a pressure drop (ΔP) measured depending on a flow rate after filling the same weight of NPZIF-8/NaPAF adsorbents and NPZIF-8 adsorbent into each of the adsorption reaction tanks having the same volume. In the adsorption reaction tank filled with the NPZIF-8 adsorbent, the pressure drop occurs rapidly as the flow rate increases, whereas in the adsorption reaction tank filled with the NPZIF-8/NaPAF adsorbents, the pressure drop progresses slowly even as the flow rate increases. This is because the NPZIF-8/NaPAF adsorbents of the present invention are in the shape of a fiber with a diameter of several tens of μm, thereby allowing smooth movement of a fluid.

A regeneration characteristic of the NPZIF-8/NaPAF adsorbents of the present invention was examined.

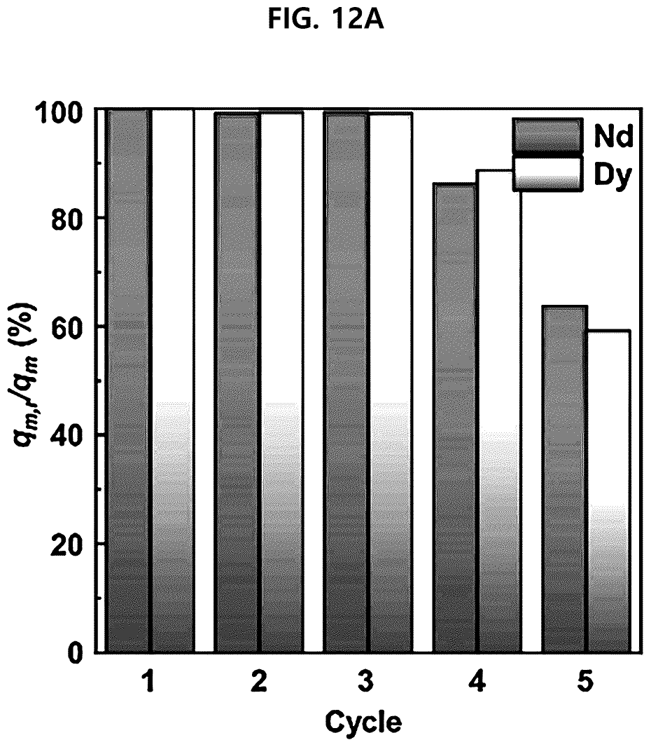

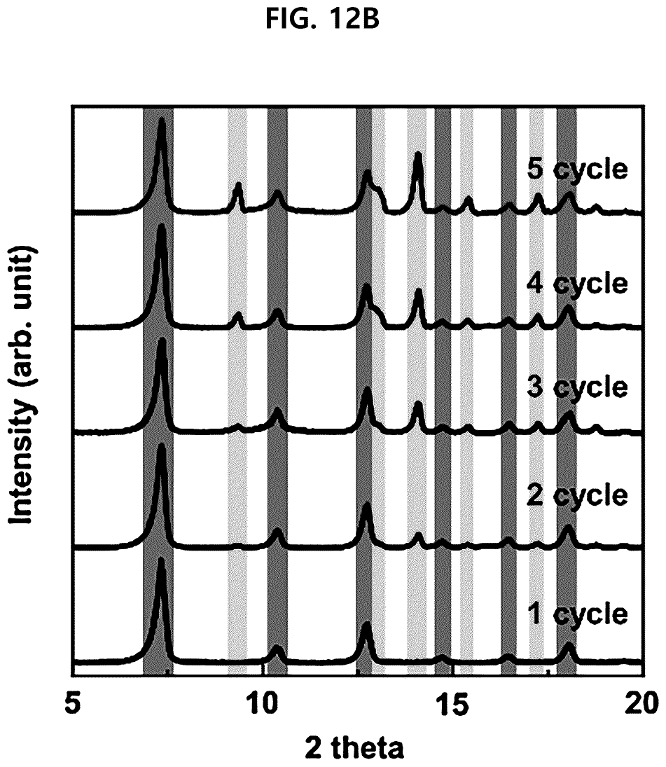

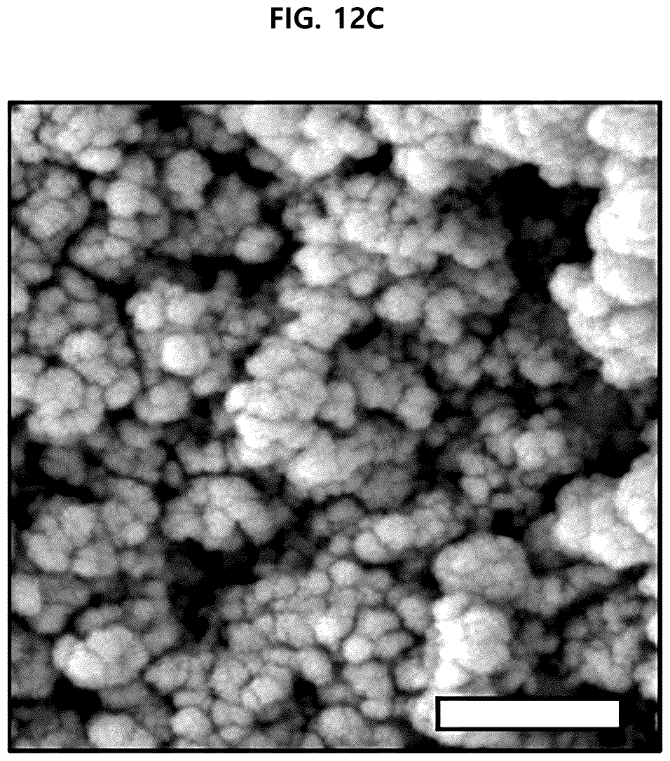

After the adsorption experiment for Nd³⁺ and Dy³⁺, according to the experimental method of desorbing Nd³⁺ and Dy³⁺ from the NPZIF-8/NaPAF adsorbents and adsorbing Nd³⁺ and Dy³⁺ again, the adsorption and the regeneration were repeated five times. As a result of the experiment, it can be seen that almost 100% of Nd³⁺ and Dy³⁺ are adsorbed even after the regeneration is repeated three times (see FIG. 12A). On the other hand, it was shown that an adsorption efficiency was decreased after the regeneration four times. The XRD and FESEM analyses for them indicated that a crystal structure of the NPZIF-8 collapsed after four regenerations (see FIGS. 12B and 12C).

What is claimed is:

1. A metal-organic framework-polymer fiber-based adsorbent having a core-shell structure, characterized in that the metal-organic framework is provided on a surface of a sodium polyacrylate (NaPA) fiber.

2. The metal-organic framework-polymer fiber-based adsorbent having the core-shell structure according to claim 1,
characterized in that a sodium carboxylate group (—COONa) is provided on the surface of the sodium polyacrylate (NaPA) fiber.

3. The metal-organic framework-polymer fiber-based adsorbent having the core-shell structure according to claim 1,
characterized in that any one of an amine group (—NH₂), a carboxyl group (—COOH), a hydroxyl group (—OH), a sulfate group (SO₄²⁻), or a phosphate group ([PO₄]³⁻) is provided on the surface of sodium polyacrylate (NaPA) fiber.

4. The metal-organic framework-polymer fiber-based adsorbent having the core-shell structure according to claim 1,
characterized in that the metal-organic framework is ZIF-8.

5. The metal-organic framework-polymer fiber-based adsorbent having the core-shell structure according to claim 1,
characterized in that the sodium polyacrylate (NaPA) fiber has several tens of μm or more in a diameter.
